(19) United States
(12) Patent Application Publication
(10) Pub. No.: US 2016/0067591 A1
(43) Pub. Date: Mar. 10, 2016

(54) GAME FOR AMUSEMENT AND TEACHING

(71) Applicant: Joan Cappello Tunny, Santa Rosa, CA (US)

(72) Inventor: Joan Cappello Tunny, Santa Rosa, CA (US)

(21) Appl. No.: 14/853,975

(22) Filed: Sep. 14, 2015

Related U.S. Application Data
(63) Continuation of application No. 13/487,626, filed on Jun. 4, 2012.

(51) Int. Cl. A63F 3/00; G09B 19/18; A63F 3/04

(52) U.S. Cl. CPC A63F 3/00063; A63F 3/00088; A63F 3/04; G09B 19/18

(57) ABSTRACT

An educational board-type game for a plurality of players has world currency as the primary subject matter. The object of the game is to travel the world and earn back the travel expense in 90-days. The game includes a durable, flexible, reusable, portable playing surface, a measuring device, color marker playing pieces and eraser, playing cards, rules, a guide, a log, and a storage cylinder. Players choose destinations and random select playing cards that have distance, time and money as transaction values. Players use strategic thinking to determine their moves and calculate foreign currency exchange and/or and or borrowing and lending to earn the expense of traveling to choice destinations. A primary intention of the game is to provide an enjoyable recreation activity for social interaction between family and friends. The game is an engaging learning activity for instruction in the social sciences that is programmable for use on an electronic device.

### CROSS-REFERENCES TO RELATED APPLICATIONS

This application is a continuation of U.S. application Ser. No. 13/487,626, entitled “GAME FOR AMUSEMENT AND TEACHING,” filed on Jun. 4, 2012, which is herein incorporated by reference in its entirety for all purposes.

### BACKGROUND OF THE INVENTION

1. Field of the invention

The present invention relates to a board-type game for amusement that has an educational purpose. The game is for serious game players and for use by students and teaching professionals for classroom instruction and curriculum development in the social sciences. The game is entertaining and involves a level of skill, competition, strategy and content that will enlist serious players. Players have fun, develop learning and strategy skills and gain knowledge in the social sciences, in particular the field of economics. The described embodiment of the present invention is known as Around the World in 90-Days.

2. Description of the Prior Art

The use of games for amusement and teaching is well known in the prior art. Serious games represent a billion dollar global market and are used today by organizations as powerful, efficient workforce tools for learning and skill development. (Derryberry, 2007) Students will participate at length in an enjoyable pursuit and the repetition in game playing is a proven learning tool. Is it argued that educators should adhere to repetition a basic learning tool that for centuries has benefitted brains around the globe. (Perry, 2012). Further, it is argued that people learn better by doing something. Educators are placing more emphasis on the design of learning activities rather than teaching activities. Activity based learning focuses on student centered activities that include interaction between the learner and an environment with resources. A high quality game is an engaging activity that allows for the participation, interaction and communication called for by this new instructional theory. Games can be used inside and outside scheduled classrooms as student centered activities that will lead to deeper and more meaningful understandings. Students learn content, develop their own meanings and construct new ideas. (Walker and Ryan, 2005). When content is viewed in different ways, students strengthen and expand their knowledge of the particular subject matter presented. The game of the present invention combines repetition with an entertaining learning activity. The preferred embodiment of the game of the present invention is an apparatus that reinforces the retention that comes with repetition and allows for creative thinking The described embodiment of the present invention improves on the prior art by providing a new and improved game.

Academics argue that the subject matter that comprises the social sciences is the single most important source for practitioners writing games. (McGowan, 2010) The social sciences differ from the physical sciences and, for the sake of better knowledge of why people behave the way they do, must value and use their own models. They are mature disciplines with no need to emulate other sciences. (Clark and Primo, 2012) For this reason, they are especially suited to game playing. Games contribute to education and training as a life-long process. The described embodiment of the present invention acknowledges the history and the popularity of games as educational tools and teaches how amusement can be used as a resource to bring the wealth of information in the social sciences to the general public through games. The present invention can be used by teachers to enhance any social studies curriculum where game players can compete in achieving an objective that can be measured and requires quantifiable resources to attain. For example, the described embodiment is specifically intended to bring about a common understanding of international economics as it relates to currency exchange, borrowing and lending. The game could focus on an understanding of the terms of trade and the most abundant resource of world countries. The present invention improves on the prior art in that it utilizes the social sciences to provide an enjoyable, entertaining and challenging game for amusement and for use as a serious educational tool that would otherwise be unavailable and that produces unexpected results. The game of the present invention through amusement contributes to human development, maturation, and learning. It imparts knowledge to the people that will lead to informed citizen participation in public decision making and to a better world.

### Game Design

Most game boards are designed with grids of squares or divided into defined spatial paths with playing pieces that have specific identities. Players must move along a predetermined path overcoming obstacles to reach the end square and win the game. Most educational games teach a specific lesson relating to facts with reinforcement for correct answers. By way of example, U.S. Pat. No. 324,535 (Clemens, 1885) is for a game apparatus designed as a chart with columns and rows and holes for placement of pegs. The purpose is for amusement and instruction, specifically to help players remember important historical dates. More recently, U.S. Pat. No. 6,102,398 (Kolleth, 2000) is a board game that has a map and path around which players progress based on answering fact questions correctly. The questions and answers are provided on cards. Similarly, U.S. Pat. No. 2,026,082 (Darrow, 1935) is a game board with forty spaces extending entirely around the perimeter of the board. Players follow this continuous path, moving their symbols according to throws of dice. The board provides a track for continuity. The game teaches trading, specifically in real estate, and presents business situations simulating those occurring in real life. The object of each player is to force the other players to quit the game because they cannot meet their financial obligations, leaving one player the winner. U.S. Pat. No. 3,939,578 (Coffey, 1976) is an educational board game designed as a tutorial system of learning specific academic subject matter that includes cards, tokens and chance means. The board is divided into academic subject areas and the cards correspond to these areas. Players move through defined numbered spaces on the periphery of the board based on the chance means and answer the questions on the board or cards that correspond to the defined spaces. Modern games are using technology or computers, popular mediums that are able to engage people for extensive periods of time. U.S. Pat. No. 6,641,400 (Kennedy, 2003) is a multi-disciplinary educational tool that is also suitable for entertainment that can include a playing board with spaces and playing dice that determine user movement on the spaces. The educational tool combines using all the senses, including sight, sound, touch and smell, and educational experiences within a single activity that teaches subject matter by simulation and can be played on a computer by one user.

The present invention is designed to promote serious learning through organized games and play. An intention is to show how games can be effective learning environments when creatively integrated into a curriculum. While the present invention can be programmed for use on a computer, a primary intention is to provide an enjoyable recreation activity for social interaction between family and friends through a board-type game apparatus. Another intention is to promote this activity and social interaction by providing an inexpensive, reusable, portable game apparatus. Acknowledging the expense of acquiring the new technology games and the technical support for maintenance, the present invention can easily be translated into software for use on a computer by a plurality of players. The experience, reflection, questioning and discussion that come with group interaction are important parts of learning. An important aspect of the present invention is having a community that develops around the game. Game community mirrors the definition of an educational community of practice. Players bring diverse experience and are valued for their contributions as the group continually advances in knowledge and skills. (Oblinger, 2006) The game of the present invention provides a framework that supports developing new knowledge through social interaction. Rather than providing a fixed game board path for lessons or instruction, the game board-type surface of the present invention allows players to determine and mark their own spatial path on a board-type surface with an identifiable image. It provides all the possible positions and allows players to create a new spatial location each round. The timeframe for game playing is flexible. The game can be played as one timed game session of eighteen rounds with a high score winner or as a series of game sessions with players building on their score in the prior game. It teaches basic concepts in the social sciences, requires skill and strategic thinking and encourages creativity. The game playing field surface of the present invention improves on the prior art that restricts players moves with predetermined spaces. The design of the present invention combines the ingredients necessary for serious games.

### Game Content

Modern games are criticized as having insipid content, being too teaching focused or being too concerned with entertainment utility. By way of example, U.S. Pat. No. 6,079,710 (Brown, 2000) is a bingo-type game to teach basic mathematics. U.S. Pat. No. 5,478,076 (Aylett, 1976) relates to a theme park. Users are entertained by traversing the attractions and structures of a theme park. The present invention builds on a basic economic concept, the covered interest differential. In large international financial transactions this involves securing a foreign loan with a forward foreign exchange currency contract. It is a conventional rule for reducing the foreign exchange risk that comes with fluctuating exchange rates. (Lindert and Kindleberger, 1982) The game uses variables from the covered interest differential, foreign currency, interest rates and time, as the means by which players earn back the money expense of traveling the world.

The content of the preferred embodiment of the game engages players in fun activity and achieves serious, measureable and sustainable learning results. Learning is an intentional outcome of the present invention. In the preferred embodiment, players gain an understanding of economics. People love the excitement of travel to exotic places. While millions of dollars are spent each year in international travel and tourism has become a major component of the world economy, most Americans do not have passports and do not travel abroad. Americans spend most of their leisure time at home. Attributed to many factors, i.e., the work ethic, the hassle and expense of air and auto travel, Americans prefer to spend time at home interacting with family and friends. Sales of board games in recent years were in the hundreds of millions of dollars. Over 250 million sets of the popular game of monopoly have been sold worldwide. In the described invention, game players travel to choice destinations on each of the seven continents. The game enlists players with the prospect of visiting interesting and exotic destinations around the world while adding value to these destinations. It provides a peaceful, enjoyable pursuit, in a relaxing atmosphere as it develops learning skills and encourages new understandings of important concepts, creative thinking and decision making

Most educational games that develop skill in collecting data, planning and strategic thinking, such as the many chess and war games, do so in a conflict environment with the goal of destroying the enemy or dominating opponents. The popular war game Stratego and other modern conflict games of strategy are based on French Patent No. 396,795 (Edan, 1909). Edan teaches strategy through a war game played on a board divided into squares with game pieces representing different military ranks U.S. Pat. No. 1,144,927 (Wunsch, 1915) is a board game for all ages. The board depicts Germany, Russia, Austria, Belgium, Turkey and France, battle strategies and fields of battle. Objectives are to be interesting and instructive while capturing opponent's flags. U.S. Pat. No. 5,026,070 (Watt, 1991) is a strategic naval warfare game played on a checker-style board with the object of capturing an opponent's naval bases. U.S. Pat. No. 6,209,873 (DeGeorge, 2001) teaches strategic and tactical decision making by simulating real combat scenarios. U.S. Pat. No. 6,981,700 (Syed, 2006) is a turn-based strategic board game similar to chess and checkers with the strategy of attack and defense improved only in difficulty to be more competitive and thereby enjoyable to players.

The content of preferred embodiment of the present invention is entertaining and useful in that it is an enjoyable activity that teaches social studies concepts important to everyday living and involves strategic thinking without conflict. Similar to chess-type games, knowing the rules and strategies are only a beginning. There is so much to learn through this game that over a lifetime players will still discover new understandings and new ways to improve their play. In the described embodiment of the present invention, players add value to their choice travel destinations. As tourists, they must purchase each choice destination's currency to cover the travel expense. Players travel the world and develop strategies that involve time, distance and money to earn back the expense of their trip. In so doing, they collect the information they need, plan their moves and use strategic thinking while they expand their knowledge of the social sciences as it relates to present day international currency exchange.

Evident in the aforementioned patents there are many games involving boards and cards and requiring skills and strategy with the object of teaching. The present invention preserves the entertainment aspect of games so as to engage players in activity that expands their knowledge base and changes nonproductive skills and beliefs. The present invention has the amusement value of a game of monopoly and chess and the learning value called for by the internationalization of the world economy. The board-type game of the present invention substantially departs from the conventional content and design of the prior art and in so doing provides a new and improved apparatus for the purpose of amusement and teaching.

### SUMMARY OF THE INVENTION

The general purpose of the present invention is for players to enjoy with others an amusing game and to make subject matter in the social sciences interesting and understandable to the ordinary person. One of the most significant events of recent years has been the internationalization of the world economy. The massive movement of goods, labor and money across national borders makes it imperative that the ordinary person understand basic principles of economics that apply worldwide. While citizenship education, the basis of mandatory schooling in the United States, requires an understanding of a free market economy, economics is not a required subject in public schools. The transformation in society is having an impact on teachers and learners and on the learning environment in all sectors. Educators worldwide are placing more emphasis on the design of learning activities to include a wider range of practices that focus more on learner activity than teacher activity and that lead to planned outcomes. Therefore, it can be appreciated that there exists a need for a new and improved game of amusement for learning important concepts that apply to our everyday lives and developing creative thinking.

The described embodiment of the present invention is for serious game players and for learning and curriculum development in economics. Game players experience currency and solve problems in a new way. The described game apparatus can be used to supplement and enhance social studies curriculum with subject matter adaptable to a game where game players compete in achieving an objective that can be measured and requires quantifiable resources to attain. The present invention is a game for amusement that engages players in a fun activity while teaching concepts relating to current events, an activity that would otherwise be unavailable.

The components of the board-type game in the described invention include a flexible, durable, reusable playing field, playing pieces that are color markers, an eraser, a measuring device, playing cards, rules, a game guide that simplifies the activity and a game log that serves as a score card. A plurality of players visit choice tourist destinations and learn about the currencies unique to countries around the world. Players use strategic planning to choose and execute their route of travel. Players select choice DESTINATION CARDs and randomly choose CURRENCY, INTEREST RATE and BONUS/PENALTY CARDs. Players calculate the expense per mile of their travel and combine the values on their hand of cards with values in the TRAVEL GUIDE to determine earnings possibilities in order to earn their trip expense. To this end, players buy and borrow, sell and lend foreign currency. The player best able to comprehend the many possibilities present in their hand of cards and to transact in the most efficient way wins. Skill is developed with continued play as players learn the process and the card possibilities. In this regard, the present invention substantially meets the need for a new and improved game for serious game players.

The educational focus of the present invention combines subject matter with learning skills such as collecting information, planning and strategic thinking making the game a serious opportunity for learning in the social sciences, in particular economics. The social sciences are not just about understanding subject matter. They are about understanding people and cultural similarities and differences. The game of the present invention is an opportunity for play to become an important contributor to human development, maturation, and learning. The learning techniques found in the present invention, primarily activity, repetition, immersion and reflection, are valuable learning tools that can be applied to the social sciences. The present invention improves on the prior art for games that relate to single subjects and reward memorization. It builds on the best of the prior art to include the many ingredients of serious games. The game of the present invention as described is a board-type game. It can also be developed as a digital game for use with an electronic device such as a computer. The present invention therefore fills the need for a new and improved game of amusement that would otherwise be unavailable.

### BRIEF DESCRIPTION OF THE DRAWINGS

The foregoing brief summary of the invention describes a board-type game for amusement that is challenging and engaging and can be used as a powerful, relevant learning tool. This and other intentions will become more apparent in the following detailed description. Such description refers to the annexed Drawings wherein:

FIG. 1 is a plan view of the preferred form of the game board-type apparatus as a whole including playing field surface, measuring device, playing cards and player color marker pieces and eraser.

FIG. 1A is a perspective view of the cylindrical tube for packaging, storing and transporting the game.

FIG. 1B is a plan view of the playing field surface measuring device. [0020] FIG. IC is a plan view of the player color marker pieces and eraser.

FIG. 1D is a plan view of a region of the playing field surface showing a spatial path as measured and marked by four players in one round of play.

FIG. 2 is a plan view of four choice cards in the preferred form of the game.

FIG. 3 is a plan view of four chance cards in the preferred form of the game.

FIG. 4 is a plan view of a one player's hand of five cards in one round of play in the preferred form of the game.

FIG. 5 is a Data Flow Diagram representation of the preferred form of the game board-type apparatus playing system.

The foregoing advantages, features and devices are apparent in the following detailed description, drawings and claims.

### DETAILED DESCRIPTION OF THE INVENTION

The following detailed description explains the best mode of making and using the present invention, an entertaining, educational game for two or more players with the earth's surface and currency as the primary subject matter. Time, distance and money are used to determine strategies for traveling around the world. The purpose of the game is for players to have fun visiting choice destinations around the world. The challenge is competing to be the first to travel to the seven continents and earn back the expense of the travel. A further purpose of the game is for players to learn economics, in particular, the supply and demand and exchange value of currency. To better understand the disclosure and to provide information that can be used for the physical design of a software program compatible with an electronic device such as a computer, the following terms and intentions as they relate to the present invention and are employed in the specification and claims are explained.

The term social science refers to a plurality of fields including: anthropology, archaeology, business administration, communication, criminology, economics, education, government, linguistics, international relations, political science, sociology and, in some contexts, geography, history, law, and psychology.

The terms supply and demand mean the exchange volume of currency the world over.

The term interest rate means the cost of or return on having access to currency for a given period of time.

The term foreign exchange rate means the rate at which currency conversion takes place, the difference in value between the US dollar and a foreign country currency.

The term spot rate is the rate at which currency conversion takes place, the value of a foreign currency in US dollars, that changes daily.

The term forward exchange rate is the conversion value at a future date of a foreign currency in US dollars that is agreed upon when a contract for exchange is made.

The term currency exchange market means the interaction of people trading currencies for various reasons.

The term forward exchange contract means a binding agreement to buy or sell a country currency at a specified rate on a future date. A forward contract requires 10% of the total contract amount at the time of contract with the remainder payable when the contract is due.

The term cross-currency exchange rate means the rate at which one foreign currency is converted to another foreign currency without having to first convert either currency into US dollars.

The term arbitrage means a transaction involving three currencies, two foreign and US dollars, where gains can be made when currency exchange rates do not exactly match up. As one of the steps you must always be selling one foreign currency for another foreign currency.

An intention of the game is to provide a peaceful, relaxing, enjoyable social learning environment where players use strategic planning in determining real world non-militaristic moves. Rather than movement of attack and defense on a predetermined grid, players create their own spatial path and in a collective effort add value to the countries they visit by spending money at each destination. At the same time they maintain and enhance their own value as they earn the travel money they spend through currency exchange.

An intention of the described embodiment of the present invention is to make game playing more worthwhile, challenging and interesting by providing activity centered instruction in the social sciences to the general public.

An intention of the game is to make classroom learning more exciting by giving intermediate, secondary and college level teachers an interactive, engaging learning activity that they can customize with social science content at different levels of difficulty.

To accomplish these intentions, game players utilize the game apparatus described in the annexed nine sheets of Drawings and in Exhibits A, B and C that follow the detailed description and are summarized below.

EXH. A, RULES OF THE GAME, include the steps in playing the game, the game constraints, definition of terms used in the game, explanation of card rates and values, game strategies and a scenario of a player's transactions from one hand of cards.

EXH. B, TRAVEL GUIDE, consists of general information, world currency overnight interest rates and currency spot rates, world precious metal spot rates, three tours, a deluxe world tour, tour of the libraries and museums of the world and backpack around the world tour and the overnight interest rates and currency spot rates for the tour continents and countries. The Travel Guide simplifies the game activity through the tours. Players who choose a tour do not have to measure distance and calculate their travel expense and have a simplified list of transaction values. Tours provide a fixed total cost and a list of tour destination overnight interest rates and currency exchange rates in destination currency in United States dollars and European Euros.

EXH. C, TRAVEL LOG, consists of a ledger for recording player scores, including the round number, player destinations and miles traveled, transactions, expenses and earnings.

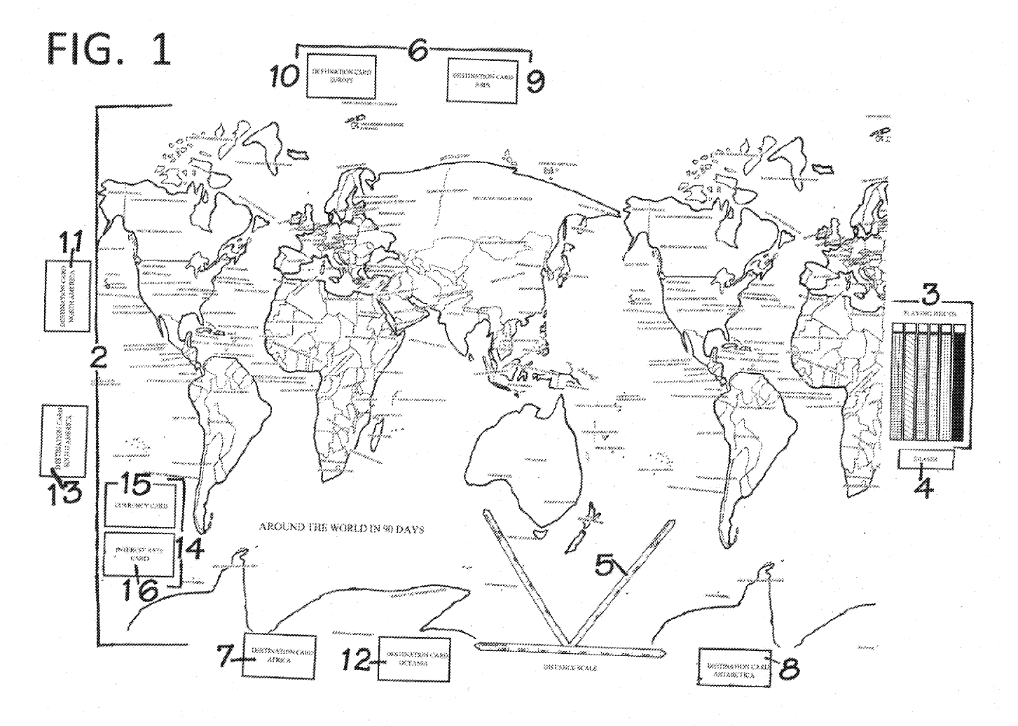

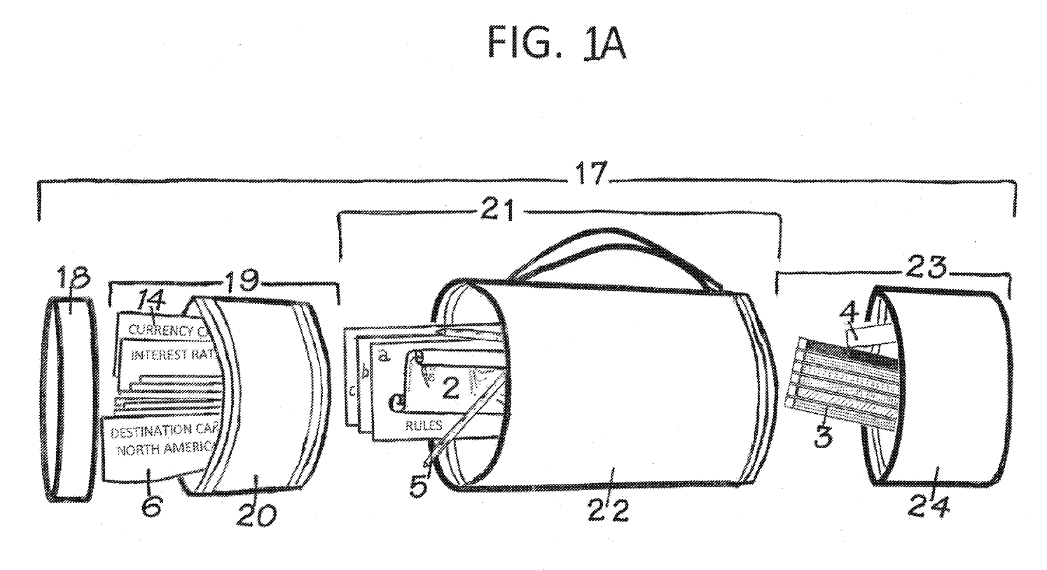

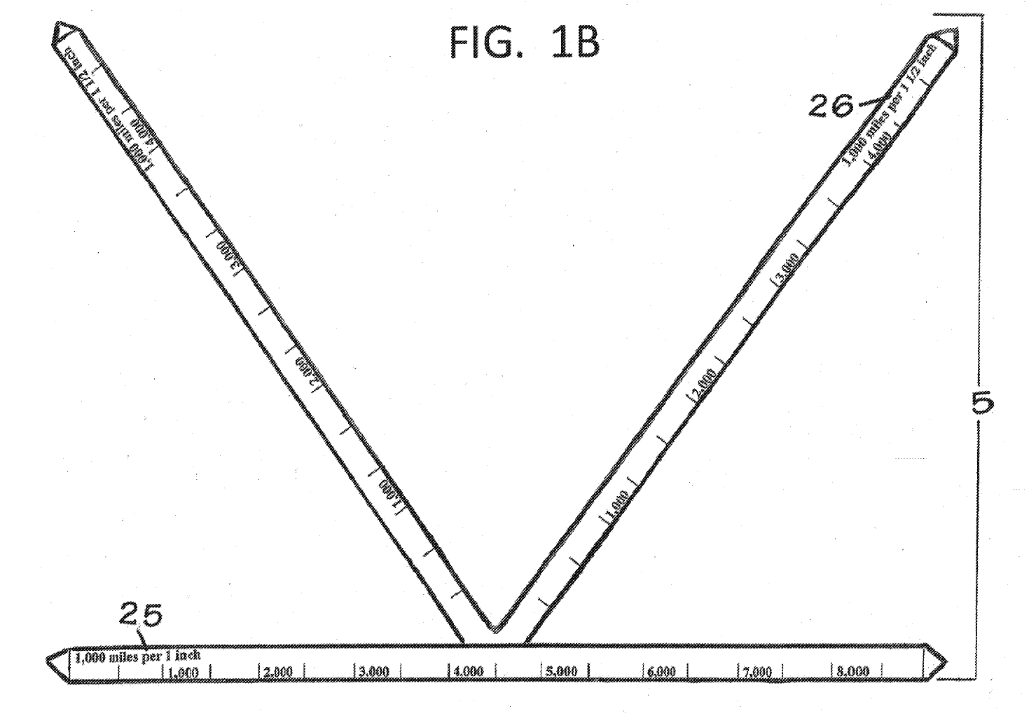

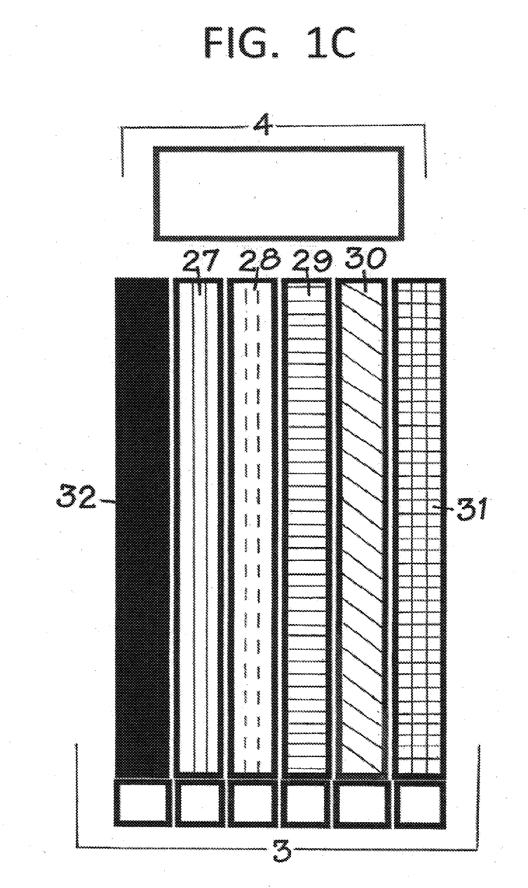

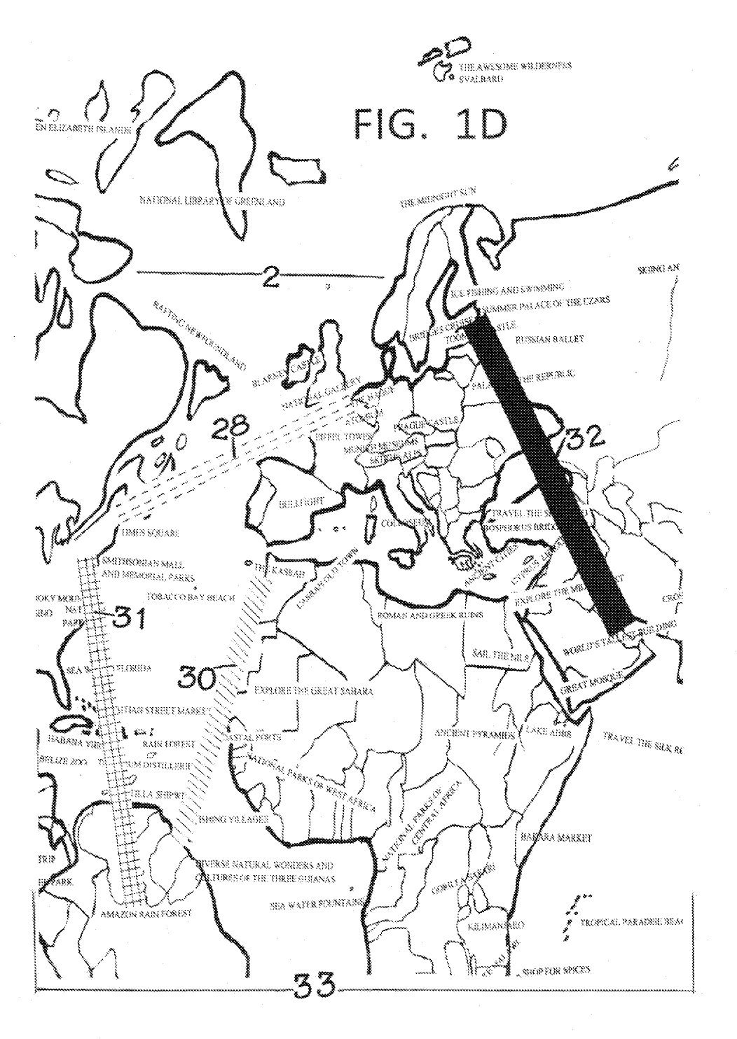

Reference is now made to the drawings, FIGS. 1 through 4, designating a new board-type game for serious game players with an educational purpose.

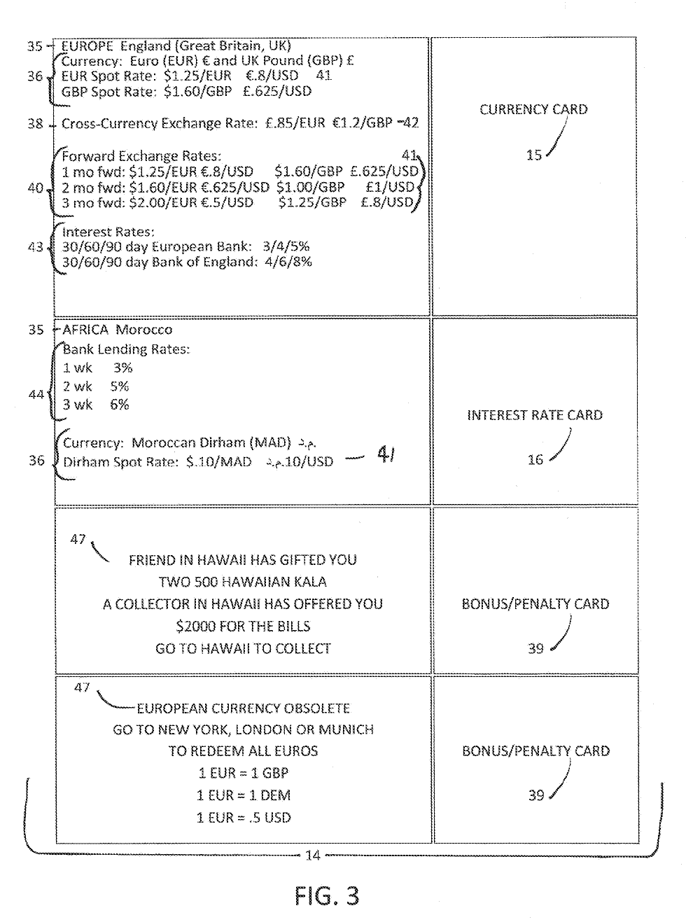

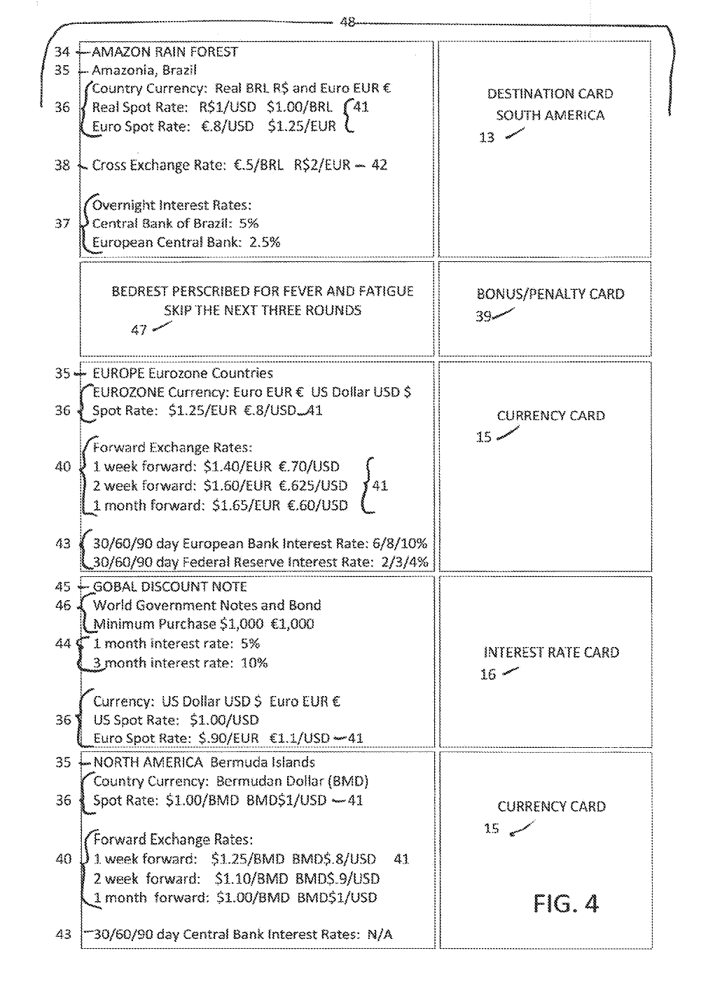

FIG. 1, the preferred form of the present invention, a board-type game apparatus is of a rectangular shape and includes the playing field surface, generally indicated at numeral 2. The game playing field is a world map. The size of the world map approximates one inch to the mile horizontally and one and one-half inch to the mile diagonally the circle distance around the earth, approximately 25,000 miles. Continents are depicted in a flat, continuous array, one full view and one half view so that distance can be measured from left to right or right to left. Locations on the DESTINATION CARD, generally designated by numeral 6, and the destinations in the tours in the TRAVEL GUIDE, EXH. B, are on the playing field surface map. The playing field surface map is made of a flexible, durable, reusable material with a transparent overlay such as plastic. Players can add destinations to those depicted on the map and mark their travel path on the map with their playing piece, indicated at numeral 3, six markers of different colors. The marked surface is erasable with the eraser, indicated at numeral 4. The map distance scale measuring device is indicated at numeral 5. The game playing choice DESTINATION CARD, numeral 6, is identified on one side by continent, AFRICA, indicated at numeral 7, ANTARCTICA, indicated at numeral 8, ASIA, indicated at numeral 9, EUROPE, indicated at numeral 10, NORTH AMERICA, indicated at numeral 11, OCEANIA, indicated at numeral 12, and SOUTH AMERICA, indicated at numeral 13, The chance cards, generally indicated by numeral 14, are identified on one side as CURRENCY CARD, indicated at numeral 15, and INTEREST RATE CARD, indicated at numeral 16. Chance cards identified on one side as BONUS/PENALTY CARD, indicated at numeral 39 in FIGS. 3 and 4, are shuffled into the chance card decks, 14 and 15. The card decks have transaction values on the second side. The card decks are placed value side down on the board-type game surface, numeral 1.

FIG. 1A The game packaging and storage cylinder, generally designated by numeral 17, is made of a light weight durable, rigid, portable material such as aluminum. The game cylinder includes a top circular piece, indicated at numeral 18, a closure with grooves that screw onto a top cylinder, generally designated by numeral 19. The top cylinder includes a tube, indicated at numeral 20, of sufficient size to store the game playing cards, 6 and 14 in FIG. 1. Tube 20 has grooves at the bottom that screw into the top of the central cylinder, generally designated by numeral 21, a tube with a handle, indicated at numeral 22, of sufficient size to store the flexible playing field surface and distance scale ruler, 2 and 5 in FIG. 1, and the RULES, indicated at letter a, TRAVEL GUIDE, indicated at letter b , and TRAVEL LOG, indicated at letter c. A bottom cylinder, generally indicated at numeral 23, includes a tube, numeral 24, of sufficient size to store the player marker pieces and eraser, 3 and 4 in FIG. 1. Tube 24 has grooves on the top that screw into the bottom of the central tube, 22. This game packaging cylinder allows for ease of packaging, storing and transporting the game.

FIG. 1B the distance scale measuring device, 5 in FIG. 1, is made of a flexible, durable material similar to the playing field surface map, 2 in FIG. 1, that adheres to the surface and is detachable and used as a ruler. Players use the distance scale to measure their distance as they travel around the world. The distance scale measures 1,000 miles per inch horizontally, indicated at numeral 25, and 1,000 miles per one and one half inch diagonally, indicated at numeral 26. The distance scale ruler is an approximate measure of distance in miles between locations on the world map. Players calculate the expense of each round of travel by multiplying the miles traveled by the travel cost per mile they select from the TRAVEL GUIDE, Vagabond at $0.10 per mile, Value at $0.20 per mile and Luxury at $0.40 per mile, EXH. B.

FIG. 1C the playing piece color markers, 3 in FIG. 1, includes marker piece blue, indicated at numeral 27, marker piece purple, indicated at numeral 28, marker piece red, indicated at numeral 29, marker piece green, indicated at numeral 30, marker piece yellow, indicated at numeral 31, marker piece black, indicated at numeral 32, and a marker eraser, 4 in FIG. 1. Players use their color piece marker, and eraser, 3 and 4, to mark their travel route each round of play and to clear the game playing field map, 2 in FIG. 1, each game of play. Individual players are identified by their color marker playing piece, 3 in FIG. 1, and their route can be easily followed during the game.

FIG. 1D is a view of a spatial area, generally designated by numeral 33, on the playing field surface map, 2 in FIG. 1, marked with four player paths, player purple, 28 in FIG. 1C, player green, 30 in FIG. 1C, player yellow, 31 in FIG. 1C, and player black, 32 in FIG. 1C. In this round player purple, 28, is traveling from TIMES SQUARE in New York City, NORTH AMERICA, to the NATIONAL GALLERY in London, EUROPE, a distance of 3,500 miles. Player purple, 28, has chosen Luxury trip expense of $0.40 a mile. Distance multiplied by expense rate equals a travel expense of $1,400. Player yellow, 31, is traveling from the SMITHSONIAN MALL in Washington, D.C., NORTH AMERICA, to the AMAZON RAIN FOREST, Amazonia, SOUTH AMERICA, a distance of 3,000 miles. Player yellow, 31, has chosen Vagabond trip expense of $0.10 a mile for a travel expense of $300. Player green, 30, is traveling from THE THREE GUIANAS, Suriname, SOUTH AMERICA, to CASABLANCA, Morocco, AFRICA, a distance of 3,600 miles. Player green, 30, has chosen Value trip expense of $0.20 a mile for a travel expense of $720. Player black, 32, is traveling from the SUMMER PALACE OF THE CZARS, St Petersburg, EUROPE/ASIA, to the THE WORLD'S TALLEST BUILDING, Dubai, ASIA, a distance of 2,700 miles. Player black, 32, has chosen Luxury trip expense at $0.40 a mile for a travel expense of $1,080. Each player has recorded in Round ONE of their TRAVEL LOG, EXH. C, two continents, their start and end destination and first travel destination, the travel distance and expense and their score.

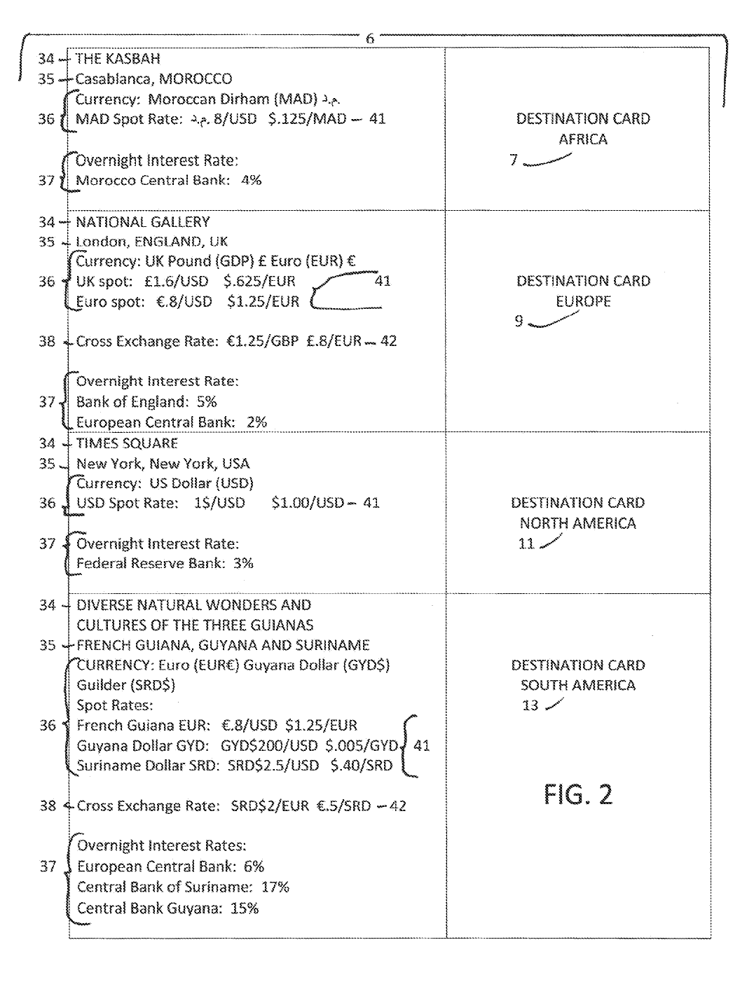

FIG. 2 depicts four choice DESTINATION CARDs, 6 in FIG. 1. One side of the card identifies the continent, AFRICA, 7 in FIG. 1, EUROPE, 9 in FIG. 1, NORTH AMERICA, 11 in FIG. 1, and SOUTH AMERICA, 13 in FIG. 1. The second side of the card gives the tourist attraction, indicated at numeral 34, the location, indicated at numeral 35, the country currency(s) and spot rate(s), indicated at numeral 36, and the country central bank overnight interest rate(s), indicated at numeral 37. DESTINATION CARD currency and spot rates, 36, can include more than one currency as on the cards for EUROPE, 9, and SOUTH AMERICA, 13. Cross-currency exchange rates, indicated at numeral 38 on card 9, are then included. The spot rate, 36, appears on the card as the US dollar value/1 unit foreignA currency and foreignA currency value/1 unit USD, indicated at numeral 41. This represents the US dollar value of one unit of foreignA currency, and the foreignA currency value of 1 US dollar. The cross-currency exchange rate appears on the card as the currency value foreignA/1 unit foreignB and the currency value foreign B/1 unit foreignA, indicated at numeral 42. This represents the currency value of one foreign currency to one unit of a second foreign currency. The time period of overnight is one day. There are opportunities for earnings from the values on the DESTINATION CARD, 6 in FIG. 1. Players have the option of current round transactions, borrowing, lending, buying and selling currency, from the currency spot rates, 36, cross-currency exchange rates, 38, and overnight interest rates, 37, on the DESTINATION CARD, 6, and with the currency spot rates and overnight interest rates given in the TRAVEL GUIDE, EXH. B.

FIG. 3 depicts four chance cards, 14 in FIG. 1 There include two from the CURRENCY CARD deck, 15 in FIG. 1, and two from the INTEREST RATE CARD deck, 16 in FIG, 1. One card chosen from each of deck 15 and 16, is a BONUS/PENALTY card, indicated at numeral 39. The values on the CURRENCY CARD and INTEREST RATE CARD include the location, 35, and the location currency and spot rate, 36. When the card location has more than one country currency, the CURRENCY CARD, 15, includes a cross-currency exchange rate, 38, and forward exchange rates, indicated at numeral 40, for each currency. The spot rate, 36, and forward rate, 40, appear on the card as the US dollar value/1 unit foreignA currency and foreignA currency value/1 unit USD, indicated at numeral 41. This represents the US dollar value of one unit of foreignA currency and the foreignA currency value of 1 US dollar. The cross-currency exchange rate appears on the card as the currency value foreignA/1 unit foreignB and the currency value foreign B/1 unit foreignA, indicated at numeral 42. This represents the currency value of one foreign currency to one unit of a second foreign currency. The time period of one day is overnight, one week is equal to five days and one month is equal to thirty days. The interest rates on the CURRENCY CARD are 30, 60, and 90 day interest rates, indicated at numeral 43. The interest rates on the INTEREST RATE CARD are weekly lending rates, indicated at numeral 44. These rates, 44, vary on the game chance INTEREST RATE CARD and appear as daily, weekly and/or monthly, and by country and global. Global cards, indicated by numeral 45 in FIG. 4, identify a debt instrument and investment constraint, indicated at numeral 46 in FIG. 4, and interest rates, 44. The BONUS/PENALTY card, 39, has moves and transactions, indicated at numeral 47, that are mandatory. The expense and earnings calculated from the rates on the cards are recorded in the round of play when the expense and earnings are subtracted or added to the player's cash in hand, in round ONE through round EIGHTEEN. For example, if the transaction is spot or overnight in the first round of the game, the expense and earnings are recorded in round ONE, a 30 day transaction is recorded in the current round and round 6, a 60 day transaction is recorded in the current round and round 12 and a 90 day transaction is recorded in the round one and the final round 18.

FIG. 4 depicts a player's hand of five cards, generally designated by numeral 48. The hand includes a choice DESTINATION CARD, 13, and four chance cards selected randomly from the CURRENCY CARD, 15, and INTEREST CARD, 16, decks on the playing surface, 1. One chance card selected from each deck, 15 and 16, is a BONUS/PENALTY CARD, 39. Player transacts using their current cash in hand and available credit from the values on their hand of cards, 48 in FIG. 4, in the following manner.

Player YELLOW has chosen as their start and end destination the SMITHSONIAN MALL, Washington, D.C., United States, NORTH AMERICA, and is planning their own trip, traveling Vagabond, at the expense of $0.10 per mile. Player has studied the Spot Rates and Interest Rates on the DESTINATION CARDs, 6, and in the TRAVEL GUIDE, EXH. B, and found that for a small number of countries, including Brazil, there is a wide difference between the rates on the playing cards and in the guide. Player in Round ONE has chosen DESTINATION CARD SOUTH AMERICA, 13, attraction AMAZON RAIN FOREST, 34, location Amazonia, BRAZIL, 35, for a travel distance of 3,000 miles and expense of $300, knowing that extreme spot earnings are a possibility. The spot rate on this card for the Brazilian Real (BRL), 36, is R$1/USD $1.00/BRL. EXH B. rates are as follows:

| COUNTRY/ | OVERNIGHT | CURRENCY SPOT |
|---|---|---|
| CURRENCY | INTEREST RATE | EXCHANGE RATE |
| Brazil/Brazilian | 10% | $.625/BRL 1.6R$/USD |
| Real (BRL) R$ | | |
| United States/United | 1.5% | $1.00/USD 1/USD |
| States of America | | |
| Dollar (USD) $ | | |

Player considers the following spot transaction: using her $10,000 as collateral for an overnight loan in the United States of the game maximum, $100,000 at 1.5%, EXH. B interest rate, for an expense of $1,500, to buy 160,000 BRL spot at $0.625/BRL, EXH. B. Lending the BRL overnight in Brazil at the 10%, EXH. B earning 16,000 BRL. Exchanging the 176,000 BRL at spot 1/USD, 36 on the DESTINATION CARD, for $176,000 and after paying back the loan and interest, earning $74,500. These earnings less travel expense of $300 would add $74,200 to the player's current cash in hand and be recorded in Round ONE the TRAVEL LOG, EXH. C. Player also considers keeping some of her game credit by borrowing less than the maximum and reducing her round ONE BRL spot earnings.

Player further considers transacting from the values on the Eurozone CURRENCY CARD, 15. Transacting from the Eurozone CURRENCY CARD, 15, and the DESTINATION CARD, 13, player uses the same borrowing to buy 160,000 BRL at $0.625/BRL, EXH. B spot rate, sell 101,500 BRL at spot 1/USD, 36 on card 13, for $101,500 to pay back the loan, exchange 58,500 BRL at the cross rate of 2BRL/EUR, 38 on card 13, for 29,250 EUR and contract to sell Euros 1 month forward at $1.65, 40 on card 15, earning $52,650 in round SIX. Player can also buy BMD dollars forward with earnings for round TWO and/or THREE. Alternatively, player can choose to use part of the borrowing maximum for each of these transactions including investing in the World Government Notes and Bonds, INTEREST RATE CARD, 16, for earnings in round SIX and/or round EIGHTEEN.

Player's hand includes a random BONUS/PENALTY card, 39, with a penalty loss of three rounds of play leaving her three continents and three rounds of transactions behind other players. Player yellow decides that taking the high earnings opportunity on her DESTINATION CARD is the best strategy.

EXB. C entries for Player YELLOW's transactions are as follows:

TRAVEL LOG

PLAYER: YELLOW
START AND END DESTINATION: SMITHSONIAN MALL, WASH., DC NORTH
AMERICA
TRAVEL EXPENSE RATE: VAGABOND $.10 PER MILE
GAME START DATE/TIME: MONDAY 4:00 PM
END DATE/TIME:

| ROUND | | | | |
|---|---|---|---|---|
| (5 Days) | TRANSACTION | EXPENSE | | SCORE |
| Destination | (Buy, Sell, Borrow, | (travel and | | (US and foreign |
| Miles | Lend) | transaction) | EARNINGS | currency in hand) |
| ONE | | $300. | | $10,000 |
| SOUTH | Borrow $100,000 at | $10,000 | $100,000 | $74,200 |
| AMERICA | 1.5% overnight | $1,500 | | |
| Brazil | Buy 160,000 BRL spot | $100,000 | 160,000 BRL | |
| 3,000 miles | at $.625/BRL | | | |
| | Lend 160,000 BRL | 160,000 BRL | | |
| | overnight at 10% | | 16,000 BRL | |
| | Sell 176,000 BRL at | 176,000 BRL | | |
| | spot 1/USD | | $176,000 | |
| | Pay back loan | $90,000 | | |
| TWO | SKIP | | | |
| THREE | SKIP | | | |
| FOUR | SKIP | | | |
| FIVE | | | | $84,200 |

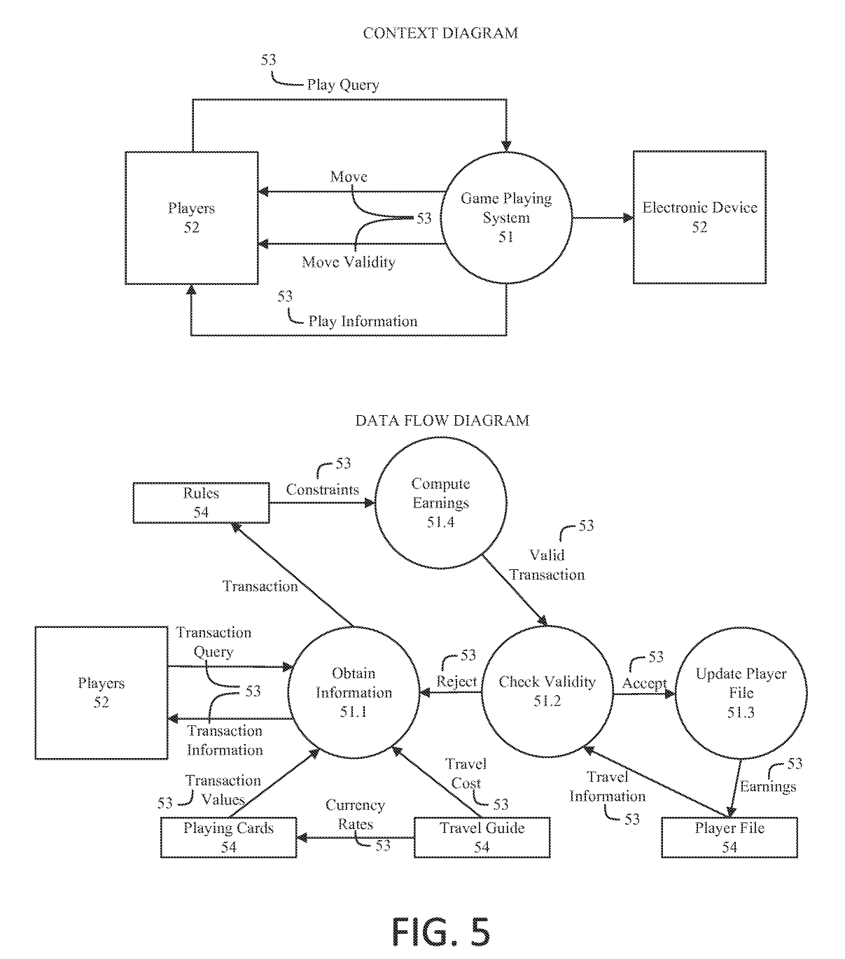

FIG. 5 is a DATA FLOW DIAGRAM, generally designated by numeral 49, that is a representation of the components of the game board-type apparatus, generally designated by numeral 1 in FIG. 1. A data flow diagram with more detail that includes all the actions in the game will become a software program compatible to an electronic device suitable for game playing. The Context Diagram, generally designated by numeral 50, shows the game playing system as a single process and is used to produce the data flow diagram, numeral 49. The Data Flow Diagram shows the major functions of the game apparatus or what the preferred embodiment of the present invention does. The diagram symbols and their meanings are a circle that shows a process and includes a verb and an object explaining what the game system does. An arrow that shows a data flow into or out of the process. Parallel lines that show a data store such as a data file or database. A square that shows an external entity that is a source from which the game playing system draws data and a source that receives information from the system. So that data flow diagrams are easy to understand and convert into software program code, the components are described in further detail in a data dictionary that describes the diagram's logic to a human rather than to a computer. For example, compute earnings would be described as a sequence of actions and instructions for carrying out the actions and would include the specific currency rate values and arithmetic involved, the data store to be read to obtain the values for computation, the action to add the transaction earnings to the players score and the information to be deleted as a result of the transaction as well as alternative courses of action.

In the context diagram, 50, what the game system does is reduced to one process, the game playing system, numeral 51. The external entities from which the system draw and receive system data, designated by numeral 52, are the players and their electronic playing device. Play query, play information, player move and move validity is the data flow, numeral 53, into and out of the process, numeral 51.

The DATA FLOW DIAGRAM, numeral 49, begins to refine the game process system and has four processes, obtain transaction information, numeral 51.1, check validity, numeral 51.2, update player file, numeral 51.3 and compute earnings, numeral 51.4. The data stores, designated by numeral 54, are rules, playing cards, travel guide, and player file provide the game playing system information. The data flow arrows, numerals 53, show the movement of data between the system processes, numerals 51, and one external entity, 52, the player. Subsequent levels of the data flow diagram will be obtained by refining individual processes whose complexity warrant it into separate data flow diagrams. For example, check validity would show a data flow of transactions for a known player to processes of evaluate currency in hand and evaluate credit availability. The final stage in the refined system will become the software program for the electronic device, 52, in the context diagram, 50, of the preferred embodiment of the board-type game apparatus of the present invention, numeral 1 in FIG. 1.

The method of playing the game referred to in the foregoing detailed description involves the following steps:

1. A plurality of players, preferably two to six, given $10,000 in United States currency, choose a color marker playing piece, numeral 3, an expense per mile rate of travel, EXH. B, and a start/finish destination. The start and finish destination can be a destination already mapped on the game playing field surface, 2, or a new destination the player adds to this markable map surface. Players can plan their own trip or choose a tour from EXH. B. Players who choose a tour must follow the tour itinerary or they are eliminated from the tour. If eliminated, they can still win the game with their round ONE score or they can choose to continue in the game by planning their own trip. Play can be individually or in groups. If players choose to group, they play the game as one player. They travel to the same agreed upon destinations and pool the cards in each player's hand. A group has the advantage of increased transaction possibilities but must choose five cards from the pool each round for transactions.

2. The youngest player begins the game by choosing a hand of cards. Player chooses one choice card, 6, a DESTINATION CARD, for their round ONE destination and four chance cards, 14, including two cards picked randomly from the CURRENCY CARD, 15, deck and two cards from the INTEREST RATE CARD, 16, deck. These five cards make up the player's hand of cards. Rotating to the left the other game players similarly choose a hand of cards.

3. In turn, all players use the distance scale measuring device, 5, to measure the distance to their first travel destination, 6, mark their route on the game playing field map using their playing piece, 3, and calculate their travel expense in US dollars, the mileage multiplied by the travel rate. Players must purchase the US dollar travel expense amount in destination currency. Transactions are made from the values on the cards in their hand to earn back this travel expense. If the chance cards in their hand are BONUS/PENALTY, 39, they must use and discard the card in the current round. Each round, the DESTINATION CARD, 6, is replaced with a new card for the next destination. The CURRENCY CARD, 15, and INTEREST RATE CARD, 16, can be saved or discarded for new cards. Used cards must be discarded.

Each round, players record in their TRAVEL LOG, EXH. C, their travel destination, mileage, currency transactions, expenses, earnings and calculate their score.

Play continues until one player has visited the seven continents and earned back their travel expense or for a maximum of eighteen rounds, that is 90 days. A round corresponds to five days. If one player does not meet this criteria, the player with the highest score, US dollar value of currency in hand, wins the game.

Important to the preferred embodiment are the game playing cards. There are 500 playing cards. These include 100 of the choice DESTINATION CARD, 6, 180 of the chance CURRENCY CARD, 15, and 180 of the chance INTEREST RATE CARD, 60, and 40 of the BONUS/PENALTY CARD, 39. The transaction values on these cards are configured to allow players to earn at least $10,000 within the 90-day time frame. For ease of calculation during game play, card exchange rates and player calculations are rounded to the nearest whole number. The transaction values include spot rates, 36, and overnight interest rates, 37, cross-currency exchange rates, 38, 1 week to 3 month currency forward exchange rates, 40, 30-60-90 day interest rates, 43, and daily, weekly and monthly interest rates for country and global lending and borrowing, 44. The time period of one day is overnight, one week is equal to five days and one month is equal to thirty days. The cards represent real and hypothetical world currencies. By way of example and not as limitation the game cards may include the following information.

The DESTINATION CARD, 6, is a choice card. Players select a DESTINATION card for each location they visit. These cards present a current round transaction opportunity. The card gives a spot rate, 36, for currencies accepted at the destination location and the destination central bank overnight interest rate, 37. Players can calculate earnings possibilities combining these rates with the rates in the TRAVEL GUIDE, EXH. B, and the chance cards they hold. When a destination accepts more than one currency and there is a cross-currency exchange rate, 38, and arbitrage is a possibility. When a DESTINATION CARD, 6, includes countries that span continents, or when players choose a BONUS/PENALTY CARD, 39, that requires travel to a continent, players have an opportunity to meet the seven continent requirement in less than seven rounds.

The DESTINATION CARD, 6, as illustrated in FIGS. 1, 2 and 4, is identified on one side by continent, 7, 8, 9, 10, 11, 12 and 13. The second side gives a destination tourist attraction, 34, and its location by City and/or Country, 35, the country currency spot rates per United States dollar, 36, and the central bank overnight interest rate, 37. Players must purchase an amount of destination country currency equal to the US dollar mileage cost of travel to the destination at the time of arrival and the amount is recorded as an expense in their TRAVEL LOG, EXH C. This purchase involves exchanging US dollars for the country currency at the spot currency and overnight interest rates on their DESTINATION card, 6, the rates on the chance cards, 14, in their hand of cards and/or in the TRAVEL GUIDE, EXH. B. Players must travel to the City and/or Country on the DESTINATION CARD to use the country currency spot and overnight interest rates on the card and in guide.

The value side on the DESTINATION CARD, 6, is configured as follows:

DESTINATION ATTRACTION
LOCATION CITY AND/OR
COUNTRY
COUNTRY CURRENCY
SPOT RATE DESTINATION COUNTRY CURRENCY:
(UNITS FOREIGN/1 USD and UNIT USD/1
FOREIGN)

| | |
|---|---|
| FOREIGN 1/USD | USD/FOREIGN 1 |
| FOREIGN 2/USD | USD/FOREIGN 2 |
| FOREIGN 3/USD | USD/FOREIGN 3 |
| FOREIGN 4/USD | USD/FOREIGN 4 |

CROSS-CURRENCY EXCHANGE RATE:
(UNITS FOREIGN1/1 FOREIGN2 UNITS FOREIGN2/1
FOREIGN1)
F1/F2 F1/F3 F1/F4
F2/F1 F2/F3 F2/F4
F3/F1 F3/F2 F3/F4
F4/F1 F4/F2 F4/F3
DESTINATION OVERNIGHT CENTRAL BANK INTEREST RATE

The cards can include up to four foreign rates. When more than one foreign currency is acceptable at a destination and listed on the card and the rates do not exactly match up there is an opportunity for arbitrage. For example, with their United States dollars (USD) a player buys one foreign currency (F1), exchanges it for another foreign currency (F2) and sells F2 for USD earning a profit. Players calculate the exchange possibilities for the currencies and borrow and/or buy low and lend and/or sell high.

The CURRENCY CARD, 15, is a chance card, 14. As illustrated in FIGS. 3 and 4, one side identifies the card as a CURRENCY CARD and the other side of the card identifies it by location, continent and city and/or country, 35, and has currency transaction values. The transaction values include spot rate, 36, cross-currency exchange rate, 38, forward exchange rates, 40, and 30/60/90 day interest rates. Players do not have to travel to the location on the CURRENCY CARD to transact with the values on the card.

The location and values on the CURRENCY CARD are configured as follows:

LOCATION CONTINENT and CITY AND/OR COUNTRY
COUNTRY CURRENCY
CURRENCY SPOT RATE:
(UNITS FOREIGN/1 USD AND UNITS USD/1 FOREIGN)

| | |
|---|---|
| FOREIGN 1/USD | USD/FOREIGN 1 |
| FOREIGN 2/USD | USD/FOREIGN 2 |
| FOREIGN 3/USD | USD/FOREIGN 3 |
| FOREIGN 4/USD | USD/FOREIGN 4 |

CROSS-CURRENCY EXCHANGE RATE:
(UNITS FOREIGN1/1 FOREIGN2 UNITS FOREIGN 2/1 FOREIGN1)
F1/F2 F1/F3 F1/F4
F2/F1 F2/F3 F2/F4
F3/F1 F3/F2 F3/F4
F4/F1 F4/F2 F4/F3
CURRENCY FORWARD EXCHANGE RATE:
1 WK FORWARD: UNITS/USD AND $ USD/FOREIGN 1 2 3 4
2 WK FORWARD: UNITS/USD AND $ USDFOREIGN 1 2 3 4
3 WK FORWARD: UNITS/USD AND $ USD/FOREIGN 1 2 3 4
1 MO FORWARD: UNITS/USD AND $ USD/FOREIGN 1 2 3 4
2 MO FORWARD: UNITS/USD AND $ USD/FOREIGN 1 2 3 4
3 MO FORWARD: UNITS/USD AND $ USD/FOREIGN 1 2 3 4
LOCATION 30/60/90 DAY INTEREST RATE

A player who receives the following chance CURRENCY CARD, 15,

AFRICA, Zimbabwe
Zimbabwe Currency: Zimbabwe Dollar (ZWD) and Moroccan Dinar
(MAD)
ZWD Spot Rate: $.002/ZWD 500/USD $.009/MAD 110/USD
MAD Spot Rate: $.01/MAD 100/USD
Cross Exchange Rate: 145ZWD/MAD .007MAD/ZWD
Forward Exchange Rate:
1 wk forward: $.00175/ZWD 570/USD $.0105/MAD 95/USD
1 mo forward: $.0015/ZWD 666/USD $.0125/MAD 80/USD
2 mo forward: $.00125/ZWD 800/USD $.0133/MAD 75/USD
3 mo forward: $.001/ZWD 1000/USD $.0105/MAD 95/USD
30/60/90 day Zimbabwe Interest Rate: 6/3/2%
30/60/90 day Moroccan Interest Rate: 3/6/9%

can transact as follows: buy 100 MAD spot $0.01, expense $1.00, exchange the 100 MAD for 14500 ZWD, and sell the 14500 ZWD for US dollars at $0.002/ZWD for $29.00 earning $28.00 from the transaction. The player can also transact for the trip expense of future round destinations based on forward exchange earnings. The forward rates for ZWD are declining and the forward rates for the MAD are increasing or unchanged. Depending on the round of play, the player can buy and sell ZWD and MAD forward to earn currency in a future round. For example, in round ONE the player can purchase 1000 MAD spot for $10.00 and sell the 1000 MAD 3 month forward for $10.50 earning $0.50 in round EIGHTEEN. Interest rates for borrowing and lending increase the earnings possibilities on the currency card. Since only 10% of the currency is required to secure the contract, 900 MAD can be loaned at 9% for 90 days increasing the forward sale to 1081 units of currency for $11.35, increasing the ROUND 18 earnings to $1.35. The player can contract to buy 57,150 ZWD 1 week forward for $100 and lend ZWD for 2 months at 3% earning 1,710 ZWD. The player can then sell the 1,710 ZWD at the spot rate in the TRAVEL GUIDE, EXH B. of $0.002 earning $3.43 in round TWELVE.

Forward exchange and lending and borrowing rates become less available for transactions as the game progresses. The time period of one day is overnight, one week is equal to five days and one month is equal to thirty days. Each round is five days and the game ends in 90 days or eighteen rounds. Only in the first round can players can transact at 90 day rates.

The INTEREST RATE CARD, 16, is a chance card, 14. As illustrated in FIGS. 3 and 4, one side of the card identifies the card as an INTEREST RATE CARD and the other has the location, continent and city and/or country, 35, or identifies it as global, 45, with the institution or debt instrument, 46. The transaction values include daily, weekly and monthly interest rates, 44. The time period of a day is overnight, a week is five days and a month is thirty days. Unless specifically designated the rates on the card apply for both borrowing and lending transactions. Players do not have to travel to the location on the INTEREST RATE card to transact with the values on the card, but can plan future destinations for the round the earnings are recorded in.

The value side of the INTEREST RATE CARD, 16, is configured as follows:

LOCATION CONTINENT and CITY AND/OR COUNTRY or
GLOBAL and INSTITUTION/DEBT INSTRUMENT/INVESTMENT
CONSTRAINT
LENDING BORROWING TIME PERIOD and PERCENTAGE RATE:
DAILY RATE
WEEKLY RATE
MONTHLY RATE and
DEBT INSTRUMENT RATES
CURRENCY AND SPOT RATE:
UNITS FOREIGN/1 USD AND UNITS USD/1 FOREIGN
FOREIGN 1/USD USD/FOREIGN 1
FOREIGN 2/USD USD/FOREIGN 2
FOREIGN 3/USD USD/FOREIGN 3
FOREIGN 4/USD USD/FOREIGN 4

A player who randomly picks the following chance INTEREST RATE CARD, 16,

GLOBAL PRIVATE LENDING FUND
15 day Individual and Corporate Notes
1,000 Currency Unit Minimum Investment
A 50%
B 10%
C 12%
E 15%
F 18%
G 20%
Currency: US dollar USD $ and Euro EUR [symbol]
US Spot Rate: $1.00/USD USD/1USD
Euro Spot Rate: $.50/EUR [symbol] 2/USD

can buy $1,000 of G Notes earning $200 in three rounds. Higher earnings are a possibility by exchanging the dollars for euros, earning 400 euros, and selling the euros at a favorable rate.

Ten percent of the chance cards are a BONUS/PENALTY CARD, 39. As illustrated in FIG. 3 and FIG. 4, one side of the card identifies it as a BONUS/PENALTY CARD and the other side of the card contains a mandatory move, 47, that can result in a gain or a loss of currency and/or time. If the player who invested in the G Notes picks the following BONUS/PENALTY CARD, 39, within the next three rounds they would lose 90% of the investment.

GLOBAL PRIVATE LENDING FUND
G NOTE RECALL AT 10% OF FACE VALUE

While the ability to quickly and accurately calculate the possibilities for earnings allows for earning the expense requirement within the first few rounds of game play, players still must travel to the seven continents to win the game and must comply with mandatory chance cards. On the basis of chance, each round players risk choosing BONUS/PENALTY CARDs that can result in their winning or losing the game. For example, three of each of the following chance game cards are shuffled into the CURRENCY CARD and INTEREST RATE CARD decks.

| | |
|---|---|
| SHOULD HAVE SKIPPED THAT | YOUR TICKET IS PASSENGER |
| FREE SAILING ADVENTURE | ONE MILLION |
| CAPTURED BY PIRATES | YOUR AIRLINE HAS AWARDED |
| OUT OF THE GAME | YOU A WORLD TRIP IN A |
| | WEEK ALL EXPENSES PAID |
| | WINNER OF THE GAME |

Currently, foreign exchange rates are determined by trading between banks and financial institutions in amounts of $1 million or more. Given specific formulas, forward exchange rates are based on points. The smallest typical point is 0.0001 which is added or subtracted from the spot rate to determine a forward rate. With billions of dollars being traded each day this makes a difference. Similarly, overnight interest rates are a fraction of a percentage and apply to other banks and large non-bank financial institutions and transfers of millions of dollars. To demonstrate this earnings potential in the game where players are day trading with $10,000, the smallest typical point has been increased four digits to 1 or a fraction thereof and the rates on the cards are flat or fixed rates at the value given not points subtracted or added to the rate. Similarly, the interest rates, in particular the overnight rate on the DESTINATION CARD, 6, reflect the highest historical prime lending rates recorded for the countries.

In economic theory, the difference in interest rates should be equal, but opposite in sign, to the forward exchange premium or discount between currencies. There would be no gain in trading US dollars for foreign currency since the outcome from interest earnings or forward currency exchange is the same. There would be no arbitrage opportunities or need for the covered interest differential.

The unpredictability of currency exchange and interest rates has been the subject of academic research in the social sciences. Since the early 1970s, the currencies of countries with high interest rates have tended to cost less, allowing for gains when trading currency. In the described embodiment of the present invention, the transaction values on the game playing cards reflect this unpredictability. In the game of the present invention as in the real world, a forward contract only requires 10% at the time of contract. 90% of the contract can be earning interest for the term of the contract. Increasing the value of the points in currency exchange and the interest rates to allow for increased earnings also points out that we live in an imperfect and changing world that rarely behaves according to theory.

The currency rates on the game CURRENCY CARD, 15, in the preferred embodiment of the present invention reflect the “roller coaster ride” term used to define current fluctuations in exchange rates. The cards give exaggerated interest rates, spot and forward currency rates for each destination to allow for measureable currency gains and losses and to bring the element of chance into the game. Similarly, the interest rates on INTEREST RATE CARD, 16, while based on historical rates, do not differentiate by lending and borrowing. In reality, lending rates can exceed deposit rates by 50% or more and vary by purpose. While the transaction values are comprised of exaggerated rates not possible in the real exchange market, the process in the game and the real world are the same.

The game playing cards of the present embodiment of the described invention include hypothetical spot currency and overnight interest rates for a central currency for each of the seven continents. To enhance the learning aspect, the cards can be revised to more realistically reflect existing world currencies and currency values.

Advantages of the game apparatus of the present invention, the low cost of manufacture, the reusable game board-type surface and ease of storage and transport, make it affordable and efficient to the buying public.

The many specificities in the above detailed description are an example of the preferred embodiment. Many other variations will occur to one having ordinary skill in the art. All changes and modifications within the scope of the invention as herein described are intended to be protected.

Exhibit A: Rules of the Game—Around the World in 90 Days

Goal of the Game: Play, Learn and Have Fun

Players travel the world going to at least one destination on each of the seven continents and earn their trip expense through foreign currency exchange, borrowing and loans. The first player to travel to each of the seven continents within 90 days, 18 rounds of play, and return to their starting destination with at least $10,000 wins the game. If a player does not win within 18 rounds, the player with the highest score, the US dollar value of the currency they hold, wins the game. Players may choose to place a time limit on each turn or game or to play a series of games. A round of play is five days, five days is one week and 30 days is one month.

### Rules

Playing the game involves the following steps:

1. A plurality of players, preferably two to six, given $10,000 in currency, choose a color marker playing piece, an expense per mile rate of travel, and a start/finish destination. The start/finish destination can be a destination that appears on the map or a new destination that the player adds to the game map playing surface. Players can plan their own trip or choose a tour from the TRAVEL GUIDE. Players who choose a tour must follow the itinerary in the guide or they are eliminated from the tour. If eliminated, they can continue in the game planning their own trip. Play can be individually or in groups. If players choose to group, they travel to the same destinations and pool their card selections. The group must choose five cards from the pool each round for transactions.

2. The youngest player begins the game by picking a hand of five cards. A hand of cards includes one choice DESTINATION CARD from the continent decks placed around the playing field map for the player's Round ONE travel destination and four chance cards, two cards from the CURRENCY CARD deck and two cards from the INTEREST RATE CARD deck. The chance cards are decked value side down on the playing field map. Players pick from the top of the decks to replace discarded cards. Rotating to the left, the other game players choose similarly from the cards.

3. The beginning player is the first to use the distance scale attached to the playing surface map to measure their Round ONE travel destination distance in miles, mark their travel route on the map using their color marker playing piece, calculate their travel expense in US dollars by multiplying the distance mileage with the travel expense rate they choose from the TRAVEL GUIDE. Player uses United States dollars to purchase the travel expense amount of destination currency upon arrival at the destination. Transactions are made from the currency and interest rates on the cards in the player's hand and in the TRAVEL GUIDE to purchase the travel expense amount in destination currency and to earn back this travel expense. Players must travel to a country to use the currency spot rates for that country on the country DESTINATION CARD and in the TRAVEL GUIDE. Players can transact with the currency and interest rates on CURRENCY CARD and INTEREST RATE cards in their hand from any destination on the map playing surface. If the chance cards in the player's hand are BONUS/PENALTY, player must use and discard the card in the current round. Each round, the DESTINATION CARD is replaced with a new card for the next travel destination. The CURRENCY CARD and INTEREST RATE CARD can be saved or discarded for new cards. Cards used in transactions must be discarded and are no longer used for play in the current game session.

4. Each move, players record in their TRAVEL LOG their travel destination, distance mileage, transactions, expenses, earnings and United States and foreign currency in hand.

5. Play continues until one player has visited the seven continents and earned back their travel expense or in 90 days, that is eighteen rounds.

6. The player who is the first to visit the seven continents and earn back their travel expense within 90 days wins the game. If one player does not meet this criteria, the player with the highest score in ROUND 18 wins the game. The highest score is the US dollar value of currency in hand.

Game constraints:

1. Players must travel to a destination on each of the seven continents.

2. Players who choose a tour from the TOUR GUIDE must keep to the itinerary to stay with the tour. If BONUS/PENALTY chance cards cause a player to be eliminated from the tour, they lose their deposit expense. They can continue in the game by planning their own trip or drop out of the game with the possibility of being the highest score winner at ROUND 18.

3. Players must travel to a destination to use the country spot rates and overnight interest rates on the DESTINATION CARD and in the TRAVEL GUIDE.

4. $10,000 in beginning game currency for each player.

5. Maximum of 100,000 units country currency for borrowing transactions per game for each player or player group with 10,000 set aside as collateral for the term of the loan (1,000 collateral per 10,000 loan).

6. Players who group can pool their hands of cards but must choose five cards for transactions.

7. 90 day time limit per game—18 rounds of play—5 days per round.

8. Cards used in a transaction must be discarded.

Definition of terms used in the game:

The term money supply and demand mean the exchange volume of currency the world over.

The term interest rate means the cost of having access to currency for a given period of time.

The term foreign exchange rate means the rate at which currency conversion takes place, the difference in value between the US Dollar and a foreign country currency.

The term spot rate is the rate at which currency conversion takes place, the value of a foreign currency in US Dollars, that changes daily.

The term forward exchange rate is the conversion value at a future date of a foreign currency in US Dollars that is agreed upon when a contract for exchange is made.

The term currency exchange market means the interaction of people trading currencies for various reasons.

The term forward exchange contract means a binding agreement to buy or sell a country currency at a specified rate on a future date. A forward contract requires 10% of the total contract amount at the time of contract with the remainder payable when the contract is due.

The term cross-currency exchange rate means the rate at which one foreign currency is converted to another foreign currency without having to first convert either currency into US dollars.

The term arbitrage means a transaction involving three currencies, two foreign and US dollars, where gains can be made when currency exchange rates do not exactly match up. As one of the steps you must always be selling one foreign currency for another foreign currency.

Explanation of card rates and values:

The time period of one day is overnight, one week is five days and one month is thirty days.

For ease of calculation, the game card currency values are numbers that divide evenly or are rounded to the closest whole number. Players round expense and earnings calculations to the nearest whole number.

The country currency spot rates and weekly and monthly forward rates appear on the game cards in the following format: $1.25/Foreign 0.8Foreign/USD. This represents the US dollar value of one unit of foreign currency, and the foreign currency value of one US dollar.

The cross-currency exchange rates appear on the card as 0.8Foreign1/Foreign2 1.25Foreign2/Foreign1. This represents the currency value of one foreign currency to one unit of a second foreign currency.

The interest rates on the DESTINATION CARD are overnight rates.

The interest rates on the CURRENCY CARD are 30, 60, and 90 day rates. 30 day rates accrue in six rounds. 60 days rates accrue in twelve day rounds. 90 days accrue in eighteen rounds.

The interest rates on the INTEREST RATE CARD are daily, weekly and monthly lending/borrowing rates by country or global. Global cards identify a debt instrument, investment constraints and interest rates.

Game strategies:

Players can simplify game play moves by choosing a tour from the TRAVEL GUIDE. Players who choose a tour do not have to measure distance or purchase destination currency. Players pay for the tour in US dollars with 25% due at the start of the game and the remainder in 90 days. Players who are eliminated from a tour forfeit their deposit. Each round of play, players on a tour choose a hand of cards including a choice DESTINATION CARD for each location on the tour. Players follow the tour destination route, mark their route on the map surface field and execute currency transactions from the values on the cards they hold to earn back their expenses. Players maximize earnings by following the transaction rule of buy and borrow low, sell and lend high.

Scenario for Player One:

Player has chosen the Deluxe World Tour at a cost of $10,000. $2,500 down and $7,500 due in 90 days.

Player is an experienced currency trader and has been following recent foreign currency exchange rates. She sees an opportunity for gains by exchanging Eurocountry currencies and US dollars during her 10-day European tour and a good possibility of a sharp rise in forward rates in China, the last destination on the tour. She always wanted to visit the city of Prague and the castles in the country of Belarus. In Round ONE she chooses the substitute rail trip to eastern European countries. While traveling to her choice destination on the train, she can trade currencies around the world.

Player's Round ONE hand of cards is as follows:

| | |
|---|---|
| PALACE OF THE REPUBLIC | DESTINATION CARD |
| Minsk, Belarus | EUROPE |
| Currency: Belarusian Rouble BYR Br and Euro EUR [symbol] | |
| BYR spot rate: Br10000/USD $.0001/BYR | |
| Euro spot rate: [symbol] .625/USD $1.60/EUR | |
| Cross-currency Exchange Rate: [symbol] 5000/BYR | |
| Br.0002/EUR | |
| Belarus Central Bank Overnight interest Rate: 12% | |
| European Central Bank Overnight Interest Rate: 1.5% | |
| EUROZONE COUNTRIES | CURRENCY CARD |
| Currency: EUR and USD | |
| Spot Rate: $.50/EUR [symbol] 2/USD | |
| Forward Exchange Rates: | |
| 1 month forward: $.625/EUR [symbol] 1.65/USD | |
| 2 month forward: $.40/EUR [symbol] 2.5/USD | |
| 3 month forward: $.50/EUR [symbol] 2/USD | |
| 30/60/90-day European Interest Rates: 10/5/1.5% | |
| 30/60/90-day US Interest Rates: 2/4/6% | |
| MAINLAND CHINA | CURRENCY CARD |
| Currency: Renminbi Yuan CNY ¥ | |
| Spot Rate: $.l6/CNY ¥6.25/USD | |
| Forward Exchange Rates: | |
| 1 month forward: $.25/CNY ¥4/USD | |
| 2 month forward: $.50/CNY V¥2/USD | |
| 3 month forward: $.8/CNY ¥1.25/USD | |
| 30/60/90-day Chinese Interest Rates: 6/12/16% | |
| UNITED STATES | INTEREST RATE |
| Treasury Notes Interest Rate: | CARD |
| 1 week: 3% | |
| 2 week: 5% | |
| 3 week: 10% | |
| Currency: US Dollar USD $ | |
| Spot Rate: $1.00/USD | |
| SECURITY DELAY AT EASTERN EUROPE | BONUS/PENALTY |
| BORDER CROSSING PASSPORT AND LUGGAGE | CARD |
| CONFISCATED FOR VERIFICATION AND SEARCH | |
| SKIP THREE ROUNDS | |

Player's BONUS/PENALTY card has eliminated her from the DELUXE WORLD TOUR. She cannot be at the end destination in Europe in ten days to continue on with the tour. She can choose to drop out of the game with a currency score of $7,500, having lost her deposit, or to continue in the game planning her own trip. She has excellent earnings opportunities with the cards in her hand.

If player decides to plan her own trip with a start and finish destination in Belarus, she can use her DESTINATION CARD to buy BYR spot, lend in Belarus, exchange for euros, sell the euros for earnings. Transactions: Buy for $100 BRL spot at $0.0001, lend 1,000,000 BRL at 12%, exchange 1,120,000 BRL for EUR at 5000BRL/EUR and sell 224 EUR spot at $1.60 for $358.40. Rounded to $360.=$260. earnings in Round ONE.

She can use her Eurozone CURRENCY CARD and for $100 buy EUR spot at $0.50, sell 200 EUR 1 mo forward at $1.65 for $330. and record $230 in earnings in Round FIVE.

She can use her Mainland China CURRENCY CARD and buy CNY spot and sell 2 mo forward. Transactions: Buy $1,000 CNY at $0.16 spot, sell 6,250 CNY 2 mo forward at $0.50 CNY for $3,125 or1 mo forward at $0.25 for $1,565. She can increase her 1 mo forward earnings by borrowing CNY for 30 days in China at 6%.

Given the US interest rates in her hand of cards and the TRAVEL GUIDE, she can greatly increase these earnings by using her $7,500 remaining cash as collateral for borrowing up to $75,000 and increasing the transaction amounts.

She can use her INTEREST RATE CARD and buy $5,000 3 wk US Treasury Notes, earning $500 in Round THREE.

Player one's Travel Log records the following transactions:

PLAYER: _PLAYER GREEN
START AND END DESTINATION: TOUR_/BELARUS EUROPE
TRAVEL EXPENSE RATE: _$.20 per mile
GAME STARTING DATE/TIME: _SAT 5:00 PM
END DATE/TIME:

| ROUND | | | | |
|---|---|---|---|---|
| (5 Days) | | EXPENSE | | SCORE |
| Destination | TRANSACTION | (travel and | | (currency |
| Travel Miles | (Buy, Sell, Borrow, Lend) | transaction) | EARNINGS | in hand) |
| Round ONE | SECURITY DELAY SKIP | $2,500 | | $10,000 |
| DELUXE | NEXT THREE ROUNDS | | | |
| WORLD TOUR | ELIMINATED FROM | | | |
| Rail Trip Eastern | TOUR | | | |
| European | | | | |
| Countries - 10 | | | | |
| days. | | | | |
| Round TWO | SKIP - NO | | | $7,500. |
| | TRANSACTIONS - | | | |
| | ELIMINATED FROM | | | |
| | TOUR | | | |
| Round THREE | SKIP - NO | | | $7,500. |
| | TRANSACTIONS | | | |
| Round FOUR | SKIP - NO | | | |
| | TRANSACTIONS | | | |
| Round FIVE | Buy $100 BRL spot at | $100. | 1M BRL | $1,760. |
| EUROPE | $.0001, lend overnight | | | 5625 BYR |
| Belarus | 1,000,000 BRL at 12%, | | | |
| Travel Miles 0 | exchange 1,120,000 BRL for | 1M BRL | 224 EUR | |
| | EUR at 5000BRL/EUR, sell | | | |
| | 224 EUR spot at $1.60 for | 224 EUR | $360. | |
| | $360. | | | |
| | $5,000 BUY 3 wk US | $5,000. | | |
| | Treasury Notes at 10% | | 6,250 CYN | |
| | Buy $1,000 CNY spot at | $1,000 | | |
| | $.l6, sell 6,250 CNY 1 mo | | | |
| | forward at $.25 for $1,565. | 625 CNY | | |
| Round SIX | | | | |
| Round SEVEN | | | | |
| Round EIGHT | | | $5,500. | |
| Round NINE | | | | |
| Round TEN | | | | |
| Round ELEVEN | | 5625 BYR | $1,565. | |

### Exhibit B: Travel Guide—Around the World in 90 Days

General Information:

The TRAVEL GUIDE simplifies the game activity.

Players can plan their own trip. Each round, players who plan their own trip measure the miles traveled and determine the travel expense. Plan your own trip travel expense is: Vagabond $0.10 per mile, Value $0.20 per mile and Luxury $0.40 per mile, and includes travel to and all expenses at each chosen destination.

Players can simplify the game by choosing a tour from the TRAVEL GUIDE. Tours have a fixed total cost and meet the distance requirements of the game. Each round, players do not measure their travel distance. They simply follow the tour itinerary and transact to earn back the cost of the tour. Players must follow the tour itinerary or they are eliminated from the tour and lose their deposit. Tours require a 25% deposit at start with remainder due in 90 days.

Tours simplify transactions by providing a list of central bank overnight interest rates and spot currency rates for each continent and each country destination included in the tours available only to players who choose a tour.

All players can transact from the destination currency spot rate and central bank overnight interest rate values on their DESTINATION CARD and on the following list, WORLD OVERNIGHT INTEREST RATES AND CURRENCY SPOT RATES, to cover their travel expense. They must travel to the destination to use these spot rates.

WORLD OVERNIGHT INTEREST RATES AND CURRENCY SPOT RATES

| | | CURRENCY |
|---|---|---|
| DESTINATION/CURRENCY CODE | | (USD/FOREIGN and |
| SYMBOL | INTEREST | FOREIGN/USD) |
| Afghanistan/Afghani AFN | 12% | $.02/AFN 50/USD |
| Africa/Afro AFR | 5% | $.10/AFR AFR10/USD |
| Albania/Albanian Lek ALL L | 13% | $.02/ALL Lek 50/USD |
| Algeria/Algerian Dinar DZD 1: . . . | 8% | $.01/DZD 1: . . . 100/USD |
| American Samoa/US Dollar USD $ | NA | $1.00/USD |
| Amsterdam/Dutch Guilder NLG f Euro | 4.5 | $1.65/USD $.60/NLG |
| EUR | | [symbol] 2.25/USD .45/NLG |
| [symbol] | | $1.60/EUR [symbol] .625/USD |
| Andorra/Euro EUR [symbol] | NA | $1.25/EUR [symbol] .8/USD |
| Angola/Angola Kwanza AOA Kz | 15%* | $.01/AOA 100Kz/USD |
| Anguilla/East Caribbean Dollar XCD $ | NA | $.40/XCD XCD$2.5/USD |
| Antarctica/Antarctican Dollar ARC | NA | $1.00/ARC 1ARC/USD |
| Antigua and Barbuda/XCD | 10% | $.40/XCD XCD$2.5/USD |
| Argentina/Peso ARS Ps$ | 15% | $.25/ARS Ps$4/USD |
| Armenia/Armenian Dram AMD | 6% | $.0025/AMD 400/USD |
| Aruba/Aruban Guilder f (Florin) AWG | 10% | $.50/AWG f/USD |
| Asia/Asian Ruble ARB | 7% | $.08/ARB |
| | | ARB12.5/USD |
| Australia/Australian Dollar AUD $ | 9% | $1.00/AUD AU$1/USD |
| Austria/Shilling S Euro EUR [symbol] | NA | .0625 [symbol] /ATS S15/EUR |
| | | $.009/ATS S10.525/USD |
| | | $1.60/EURO [symbol] .625/USD |
| Azerbaijan/Azerbaijani Manat AZM m | 20% | $1.25/AZM m.8/USD |
| Bahama Islands/Bahamian Dollar BSD $ | 5% | $1.00/BSD $1/USD |
| Bahrain/Bahraini Dinar BHD [symbol] | 8% | $2.50/BHD [symbol] 4/USD |
| Bangladesh/Taka BDT | 15% | $.0125/BDT 80/USD |
| Barbados/Barbadian Dollar BBD Bds | 10% | $.50/BBD Bds2/USD |
| Belarus/Belarusian Ruble BYR Br | 8% | $.000125/BYR |
| | | Br8000/USD |
| Belgium/Franc BEF fr Euro EUR [symbol] | 9% | [symbol] 2.5/BEF 40fr/EUR |
| | | $.0333BEF 30fr/USD |
| | | $.625/EUR [symbol] 1.6/USD |
| Belize/Belize Dollar BZD BZ$ | 14% | $.50/BZD BZ$2/USD |
| Benin/Central African Franc CFA | NA | $.002/XAF |
| | | CFAF500/USD |
| Bermuda/Bermudian Dollar BMD $ | NA | $1.00/BMD |
| Bhutan/Ngultrum BTN and | 14% | $.02/BTN 50/USD |
| Indian Rupee INR | | |
| Bolivia/Boliviano BOB $b | 12% | $.125/BOB $b8/USD |
| Bosnia Herzegovina/Convertible Mark BAM | 8% | $.80/BAM km1.25/USD |
| Botswana/Pula BWP P | 15% | $.125/BWP P8/USD |
| Bouvet Island/Norwegian Krone NOK kr | NA | $.20/NOK kr5/USD |
| Brazil/Real BRL R$ | 10% | $.625/BRL R$1.6/USD |
| Brunei/Darussalam Dollar BND Br$ | 5% | $.80/BND Br$1.25/USD |
| Bulgaria/Bulgaria Lev BGL | 10% | $.80/BGL 1.25/USD |
| Burkina Faso/Central African XAF | NA | $.002/XAF 500/USD |
| Burundi/Franc BIF Fbu | 16% | $.0008/BIF |
| Cambodia/Riel KHR | NA | $.0002/KHR 5000/USD |
| Cameroon/Central African XAF | 15% | $.002/XAF 500/USD |
| Canada/Canadian Dollar CAD | 6% | $1.00/CAD 1/USD |
| Cape Verde/Escudo Caboverdiano CVE | 10% | $.01/CVE Esc100/USD |
| Cayman Islands/Dollar KYD | NA | $1.25/KYD 80/USD |
| Central African Franc XAF | 15% | $.002/XAF 500/USD |
| Chad/Central African Franc XAF | 15% | $.002/XAF 500/USD |
| Chile/Chilean Peso CLP Ch$ | 13% | $.002/CLP Ch$500/USD |
| China/Yuan Renminbi CNY ¥ | 7% | $.125/CNY ¥8/USD |
| Christmas Island/Australian Dollar AUD | NA | $1.00/AUD Au$1/US |
| Cocos Islands/Australian Dollar AUD Au$ | NA | $1.00/AUD Au$1/US |
| Colombia/Colombian Peso COP COL$ | 12% | $.000625/COP |
| | | COL$1600/USD |
| Comoros/Comorian Franc KMF | 10% | $.002/KMF 500USD |
| Congo, Dem. Rep./Congolese Franc CDF Fr | 25%* | $.001/CDF Fr1000/USD |
| Congo, Republic/Central African XAF | 15%* | $.002/XAF 500/USD |
| Cook Islands/New Zealand Dollar NZD $ | NA | $.80/NZD 1.25/USD |
| Costa Rica/Costa Rican Colón CRC (/l | 20%* | $.002/CRC (/l500/USD |
| Cote d'Ivoire/West African franc XOF | NA | $.002/XOF 500/USD |
| Croatia/Kuna HRK Kn | 10% | $.20/HRK Kn5/USD |
| Cuba/Peso CUP P and CUC $ | NA | $.04/CUP P25/USD |
| | | $1.00/CUC 1$/USD |
| | | .05$/CUP P20/CUC |
| Curacao/Netherlands Antillean florin ANG | NA | $.625ANG/1.6f/USD |
| Cyprus/Cypriot Pound CYP £C Euro EUR | 7% | [symbol] 1.6/CYP £C.625/EUR |
| [symbol] | | $2.00/CYP £C.5/USD |
| | | $1.60/EUR [symbol] .625/USD |
| Czech Republic/Koruna CZK | 6% | $.0625/CZK 16/USD |
| Denmark/Danish Krone DKK Kr | NA | $.20/DKK kR5/USD |
| Djibouti/Djibouti Franc DJF Fr | 11% | $.00625/DJF [symbol] |
| Dominica/East Caribbean Dollar XCD | 9% | $.40/XCD 2.5/USD |
| Dominican Republic/Peso DOP DR$ | 15% | $.025/DOP 40DR$/USD |
| East Caribbean Dollar XCD | NA | $.40/XCD 2.5XCD/USD |
| Ecuador/Sucre ECS | 10% | $.00004/ECS |
| Egypt, Arab Republic/Egyptian Pound EGP | 12% | $.20/EGP 5/USD |
| El Salvador/Colon SVC (/l | NA | $.125/SVC (/l8/USD |
| Equatorial Guinea/Central African Franc | 15% | $.002/XAF 500/USD |
| Eritrea/Eritreian Nakfa ERN Nfa | NA | $.0625/ETB Nfa16/USD |
| Estonia/Kroon EEK Kr Euro EUR [symbol] | 8% | [symbol] .0625/EEK 16Kr/EUR |
| | | $.1250/EEK 8Kr/USD |
| | | $1.60/EUR [symbol] .625/USD |
| Ethiopia/Birr ETB | 7% | $.05/ETB 20/USD |
| Eurozone Countries**/Euro EUR [symbol] | 3% | $.625/EUR 1.6 [symbol] /USD |
| Falkland Islands/Falkland Pound FKP | NA | $1.60/FKP .625/USD |
| Faroe Islands/Danish Krone DKK Kr | NA | $.20/DKK Kr5/USD |
| Fiji Islands/Dollar FJD | 9% | $.50/FJD 2/USD |
| Finland/Euro Markka FIM Mk EUR [symbol] | NA | [symbol] 16/FIM 6.25Mk/EUR |
| | | $.20/FIM 5Mk/USD |
| | | $1.60/EUR [symbol] .625/USD |
| France/Franc [symbol] Euro EUR [symbol] | NA | $.20/FRF 5FRF/USD |
| | | .16 [symbol] /FRF 6.25 FRF/EUR |
| | | $1.60/EUR [symbol] .625/USD |
| French Guiana/Euro EUR [symbol] | NA | $1.60/EUR [symbol] .525/USD |
| French Polynesia/French Polynesia Franc | NA | $.0125/XPF 80/USD |
| Gabon/Central African Franc XAF | 15% | $.002/XAF 500/USD |
| Gambia/Dalasi GMD D | 30%* | $.025/GMD D40/USD |
| Georgia/Lari GEL | 20% | $.625/GEL 1.6/USD |
| Germany/Mark DEM M and Euro EUR [symbol] | 5% | $1.60/EUR [symbol] .625/USD |
| | | $1.60/DEM M.625/USD |
| | | $1.60/EUR [symbol] .625/USD |
| Ghana/New Cedi GHS GH¢ | 12% | .625/GHC GH¢1.6/USD |
| Gibraltar/Gibraltar Pound GIP £G | NA | $1.60/GIP £G.625/USD |
| Greece/Drachma GRD [symbol] and Euro EUR [symbol] | NA | [symbol] .003/GRD [symbol] 330EUR |
| | | $.004/GRD [symbol] 250/USD |
| | | $.625/EUR [symbol] 1.60/USD |
| Greenland/Danish Krone DKK Kr | NA | $.20/DKK Kr5/USD |
| Grenada/East Caribbean Dollar XCD | 10% | $.40/XCD 2.5/USD |
| Guam/US Dollar USD | NA | $1.00/USD |
| Guatemala/Quetzal GTQ Q | 12% | $.125/GTQ Q8/USD |
| Guinea/Franc GNF Gfr | NA | $.0001/GNF [symbol] |
| Guyana/Dollar GYD | 14% | $.005/GYD 200/USD |
| Haiti/Gourde HTG G | 20% | $.025/HTG G40/USD |
| Honduras/Lempira HNL L | 17% | $.05/HNL L20/USD |
| Hong Kong SAR, China/Dollar HKD $ | 7% | $.125/HKD HK$8/USD |
| Hungary/Forint HUF Ft | 10% | $.005/HUF Ft200/USD |
| Iceland/Icelandic Króna ISK Ikr | 17% | $.01/ISK Ikr100/USD |
| India/Indian Rupee INR | 12% | $.02/INR 50/USD |
| Indonesia/Rupiah IDR Rp | 15% | $.0001/IDR |
| | | Rp10,000/USD |
| Iran, Islamic Rep./Iranian Ria IRR [symbol] | 12% | $.0001/IRR |
| | | [symbol] 10,000/USD |
| Iraq/Iraqi Dinar IQD . . . | NA | $.0001/IQR |
| | | . . . 10,000/USD |
| Ireland/Irish Punt IEP IR£ and Euro EUR [symbol] | 3% | [symbol] 125 = 1 IEP IR£.8 = 1 |
| | | EUR |
| | | $1.60/IEP IR£.625 = 1 |
| | | USD |
| | | $1.25/EUR .8/USD |
| Israel/Shekel ILS | 7% | $.40/ILS 2.5/USD |
| Italy/Lira ITL [symbol] Euro EUR [symbol] | 6% | [symbol] .0005 = 1 ITL [symbol] 1900 = 1 |
| | | EUR |
| | | $.0007 = 1 ITL [symbol] 1450 = |
| | | 1USD |
| | | $1.60/EUR [symbol] .625/USD |
| Jamaica/Jamaican Dollar JMD J$ | 16% | $.01/JMD J$100/USD |
| Japan/Yen JPY ¥ | 2% | $.01/JPY ¥100/USD |
| Jordan/Jordanian Dinar JOD . . . | 9% | $1.60/JOD [symbol] |
| Kazakhstan/Tenge KZT | NA | $.008/KZT 125/USD |
| Kenya/Kenyan Shilling KES KSh | 13% | $.01/KES KSh100/USD |
| Kiribati/Australian Dollar AUD AU$ | NA | $.10/AUD AU$10/USD |
| North Korea, Dem. Rep./NK Won KPW [symbol] | NA | $.008/KPW [symbol] 125/USD |
| South Korea, Rep./SK Won KRW [symbol] | 7% | $.001/KRW [symbol] |
| Kosovo/Euro EUR [symbol] | 14% | $1.60/EUR [symbol] .625/USD |
| Kuwait/Kuwaiti Dinar KWD . . . | 8% | $4.00/KWD . . . .25/USD |
| Kyrgyz Republic/Kyrgyzstani Som KGS | 25%* | $.02/KGS 50/USD |
| Laos/Kip LAK | 30%* | $.0001/LAK 10,000/USD |
| Latvia/Lats LVL Ls | 10% | $2.00/LVL Ls.25/USD |
| Lebanon/Lebanese Pound LBP | 10% | $.000625/LBP [symbol] |
| Lesotho/Loti LSL L and | 16% | $.125/LSL L8/USD |
| South African Rand ZAR R | | $.1514/ZAR |
| | | R6.605/USD R9.5/LSL |
| Lesser Antilles/Yent | NA | NA |
| Liberia/Liberian Dollar LRD $ | 15% | $.01/LRD $100/USD |
| Libya/Libyan Dinar LYD . . . | 6% | $.80/LYD . . . 1.25/USD |
| Liechtenstein/Swiss Franc CHF Fr | NA | $1.25/CHF Fr.8/USD |
| Lithuania/Litas LTL Lt | 7% | $.40/LTL Lt2.5/USD |
| Luxembourg/Franc LUF Fr Euro EUR [symbol] | NA | [symbol] .025/LUF Fr40/EUR |
| | | $.03333/LUF Fr30/USD |
| | | $1.60/EUR [symbol] .625/USD |
| Macao SAR, China/Pataca MOP P | 8% | $.125/MOP P8/USD |
| Macedonia/Macedonian Dinar MKD | 10% | $.025/MKD 40/USD |
| Madagascar/Ariary MGA Ar | 45%* | $.0005/MGA |
| | | Ar2,000/USD |
| Malawi/Malawian Kwacha MWK MK | 6% | $.0001/MWK |
| | | MK10,000/USD |
| Malaysia/Ringgit MYR RM | 6% | $.40/MYR RM2.5/USD |
| Maldives/Rufiyaa MVR | 13% | $.0625/MVR 16/USD |
| Mali/Central African Franc XOF | NA | $.002/XOF 500/USD |
| Malta/Lira MLT Lm and Euro EUR [symbol] | 6% | [symbol] 2.5/MLT Lm.4/EUR |
| | | $.0333/MLT Lm.30/USD |
| | | $1.60/EUR [symbol] .625/USD |
| Marshall Islands/USD | NA | 1/USD |
| Mauritania/Ouguiya MRO [symbol] | 25%* | $.004/MRO [symbol] 250/USD |
| Mauritius/Rupee MUR Rs | 20%* | $.025/MUR Rs40/USD |
| Mayotte/Euro EUR [symbol] | NA | $1.60/EUR [symbol] .625/USD |
| Mexico/Mexican New Peso MXN MEX$ | 7% | $.08/MXN |
| | | MEX$12.5/USD |
| Micronesia/USD | 15% | 1/USD |
| Moldova/Moldovian Leu MDL | 20% | $.08/MDL [symbol] |
| Monaco/Euro EUR [symbol] | NA | $1.60/EUR [symbol] .625/USD |
| Mongolia/Tugrik MNT [symbol] | 25% | $.0008/MNT [symbol] |
| Montenegro/Euro EUR [symbol] | 10% | $1.60/EUR [symbol] .625/USD |
| Morocco/Moroccan Dirham MAD [symbol] | 4% | $.01/MAD [symbol] 100/USD |
| Mozambique/Metical MZM Mt | 20%* | $.00004/MZM |
| | | Mt25,000/USD |
| Myanmar (Burma)/Kyat MMK K | 17% | $.16/MMK K6.25/USD |
| Namibia/Namibia Dollar NAD N$ | 13% | $.16/NAD N$6.25/USD |
| South African/Rand ZAR R | | $.1514/ZAR |
| | | R6.605/USD R.25/NAD |
| Nepal/Nepalese Rupee NPR | 8% | $.01/NPR NPR100/USD |
| Netherlands/Dutch Guilder NLG Netherlands | 4% | $.625/NLG f1.6/USD |
| Antillean guilder ANG f and Euro EUR [symbol] | | 2.2f/EUR [symbol] .4545/NLG |
| | | $.5555/ANG f1.8/USD |
| | | 2.25f/EUR .4444/NLG |
| | | $1.60/EUR [symbol] .625/USD |
| New Caledonia/French Pacific Franc XPF | NA | $1.0565/XPF |
| | | XPF.9465/USD |
| New Zealand/Dollar NZD NZ$ | 12% | $.80/NZD NZ$1.25/USD |
| Nicaragua/Córdoba NIC C$ | 14% | $.05/NIC C$20/USD |
| Niger/Central African Franc XAF | NA | $.002/XAF 500/USD |
| West African Franc XOF and Euro EUR [symbol] | | 655/EUR |
| | | $.002/XOF 500/USD |
| | | 655/EUR |
| | | $1.60/EUR [symbol] .625/USD |
| Nigeria/Naira NGN | 16% | $.00625/NGN 160/USD |
| North America/Dollar NAD | 2% | $.625/NAD [symbol] |
| Norway/Norwegian Krone NOK kr | 7% | $.20/NOK kr5/USD |
| Oceania/Dollar | NA | $.625/OCD OCD1.6/USD |
| Oman/Omani Rial OMR | 7% | $2.50/OMR [symbol] .4/USD |
| Pakistan/Pakistani Rupee PKR Rs | 14% | $.01/PKR Rs100/USD |
| Palau/USD | NA | $1.00/USD |
| Panama/Balboa PAB B/. | 8% | $.80/PAB B/.1.25/USD |
| Papua New Guinea/Kina PGK K | 10% | $.40/PGK K2.5/USD |
| Paraguay/Guarani PYG | 20% | $.00025/PYG 4000/USD |
| Peru/Neuvos Sole PEN S/. | 15% | $.40/PEN 1.25 S/./USD |
| Philippines/Peso PHP | 8% | $.02/PHP 50/USD |
| Pitcairn Island/New Zealand Dollar NZD | | $.80/NZD 1.25/USD |
| Poland/New Zloty PLN [symbol] | 5% | $.40/PLN [symbol] 2.5/USD |
| Portugal/Escudo PTE Euro EUR [symbol] | 3% | [symbol] .005/PTE 200/EUR |
| | | $.00625/PTE 160/USD |
| | | $1.60/EUR [symbol] .625/USD |
| Puerto Rico/US Dollar USD | 1.5% | $1.00/USD |
| Qatar/Qatari Riyal QAR. | 7% | $.25/QAR. 4/USD |
| Romania/Romanian Leu RON | 15% | $4.00/RON .25/USD |
| Russian Federation/Ruble RUB py6. | 12% | $.04/RUB py6.25/USD |
| Rawanda/Franc RWF [symbol] | 16% | $.0002/RWF |
| | | [symbol] 5,000/USD |
| Samoa/Tālā WST WS$ | 12% | $.40/WST WS$2.5/USD |
| San Marino/Euro EUR [symbol] | 7% | $1.60/EUR [symbol] .625/USD |
| Sao Tome and Principe/Dobra STD | NA | NA |
| Saudi Arabia/Saudi Riyal SAR .(., | NA | $.25/SAR .(.,4/USD |
| Senegal/West African Franc XOF and | NA | $.002/XAF 500/USD |
| Central African XAF | | 655/EUR |
| | | $.002/XOF 500/USD |
| | | 655/EUR |
| Serbia/Serbian Dinar RSD | 16% | $.0118/RSD 85/USD |
| Seychelles/Rupee SCR SR | 10% | $.08/SCR SR12.5/USD |
| Sierra Leone/Leone SLL Le | 15% | $.0002/SLL [symbol] |
| Singapore/Dollar SGD | 5% | $.85/SGD 1.1765/USD |
| Slovakia/Koruna SKK Sk Euro EUR [symbol] | 8% | [symbol] .03333/SKK 30Sk/EUR |
| | | $.04/SKK 25Sk/USD |
| | | $1.60/EUR [symbol] .625/USD |
| Slovenia/Tolar SIT Euro EUR [symbol] | 6% | [symbol] .0042/SIT 240SIT/EUR |
| | | $.0056/SIT 180 SIT/USD |
| | | $1.60/EUR [symbol] .625/USD |
| Solomon Islands/Dollar SBD | 15% | $1514/SBD 6.605/USD |
| Somalia/Somali Shilling SOS S | NA | $.0005/SOS S2,000/USD |
| South Africa/South African Rand ZAR R | 15% | $.125/ZAR R8/USD |
| South America/Peso SAP | 12% | $.20/SAP SAP5/USD |
| Spain/Peseta ESP Pts Euro EUR [symbol] | NA | [symbol] .0061/ESP 165Pts/EUR |
| | | $.008/ESP 125Pts/USD |
| | | $1.60/EUR [symbol] .625/USD |
| Sri Lanka/Sri Lankan Rupee LKR Rs and | NA | $.008/LKR 125Rs/USD |
| Indian Rupee INR | | $.50/INR 2/USD |
| | | .4/LKR Rs2.5/INR |
| St Helena/St Helena Pound SHP £ | NA | $1.60/SHP .625£/USD |
| Sudan/Sudanese Pound SDG £ | NA | $.40/SDG 2.5£/USD |
| Suriname/Guilder SRG f | 15%* | $.0003/SRG f3200/USD |
| Svalbard and Jan Mayen Islands/Norwegian | NA | $.20/NOK Kr5/USD |
| Krone NOK kr | | |
| Swaziland/Lilangeni SZL L and | 14% | $.125/SZL L8/USD |
| South African Rand R | | $.125/ZAR R8/USD |
| | | R1.0526/SZL |
| Sweden/Swedish Krona SEK kr | 5% | $.125/SEK kr8/USD |
| Switzerland/Swiss Franc CHF Fr | 3% | $1.25/CHF Fr.8/USD |
| Syrian Arab Republic/Syrian Pound SYP £S | 10% | $.02/SYP £S50/USD |
| Tahiti Fr. Polynesia/French Pacific Franc | NA | $.01/XPF 100/USD |
| Taiwan/New Taiwan Dollar TWD | NA | $.025/TWD 40/USD |
| Tajikistan/SomoniTajik TJS | 15% | $.20/TJS 5/USD |
| Tanzania/Tanzanian Shilling TZS | 16% | $.000625/TZS [symbol] |
| Thailand/Baht THB | 7% | $.025/THB 40/USD |
| Tibet/Yuan Renminbi CNY ¥ | NA | $.125/CNY ¥8/USD |
| Tonga/Pa'anga TOP | 12% | $.625/TOP 1.6/USD |
| Trinidad and Tobago/Dollar TTD | 10% | $.125/TDD 8/UAS |
| Tunisia/Tunisian Dinar TND [symbol] | 3% | $.80/TND [symbol] 1.25/USD |
| Turkey/New Turkish Lira TRY | NA | $.625/TRY 1.6/USD |
| Uganda/Ugandan Shilling UGX | 10% | $.0004/UGX 2500/USD |
| Ukraine/Hryvna UAH | 10% | $.125/UAH 8/USD |
| United Arab Emirates/Arab Emirates Dirham | 0% | $.25/AED . . .)4/USD |
| United Kingdom/Pound Sterling GBP £ | 5.5% | $.80/GBP £1.25/USD |
| United States/United States of America Dollar | 1.5% | $1.00/USD |
| Uruguay/Uruguayan Peso UYU | 12% | $.05/UYU 20/USD |
| Uzbekistan/Uzbekistani Som UZS | NA | $.0005/UZS . . .)2000/USD |
| Vanuatu/Vatu VUV Vt | 8% | $.01/VUV Vt100/USD |
| Venezuela/Bolivar Fuerte VEF | 20% | $.25/VEF 4/USD |
| Vietnam/Viet Nam Dông VND | 15% | $.00005/VND |
| | | 20000/USD |
| Virgin Island/USD $, UK Pound GBP £ and | NA | $.80/GBP £1.25/USD |
| East Caribbean Dollar XCD | | $.40/XCD 2.5XCD/USD |
| | | £.25/XCD 4XCD/GBP |
| West African Franc CFA c | NA | $.002/CFA c500/USD |
| Yemen, Rep./Yemen Riyal YER [symbol] | 18% | $.004/YER [symbol] 250/USD |
| Zambia/Zambian Kwacha ZMK ZK | 10% | $.0002/ZMK |
| | | ZK5,000/USD |
| Zimbabwe/Dollar ZWK | 150%* | $.0025/ZWK |
| | | 400ZWK/USD |

*Borrowing Only Rate
*Eurozone countries currently consist of Austria, Belgium, Cyprus, Estonia, Finland, France, Germany, Greece, Ireland, Italy, Luxembourg, Malta, the Netherlands, Portugal, Slovakia, Slovenia, and Spain. [symbol]
indicates data missing or illegible when filed

WORLD SPOT RATES FOR PRECIOUS METALS

PER OZ.
GOLD XAU = $1524.00 [symbol] 1189
PLATINUM XPT = $1405.00 [symbol] 1097
SILVER XAG = $27.55 [symbol] 21.5
PER LB.
COPPER = $4.00 [symbol] 3.3

### Tours—Deluxe World Tour

TOTAL COST: $10,000.00 ($2,500 Deposit with remainder due at end of tour) START AND END DESTINATION: The Colloseum, Rome, Italy, Europe.

Itinerary:

NOTE: Travelers who choose a substitute must travel at their own expense to the continent end destination within the destination travel time to continue with the tour:

1. EUROPE: 10 days explore Spain, Portugal, Greece and Italy. First class cruise ship accommodations from Italy to North America end destination the Great Lakes.

Substitutes:

A. Cruise the Mediterranean Islands including Cyprus, Sicily, Majorca and Minorca. B. Rail trip Eastern European countries including Prague in the Czech Republic and Belarus, Estonia, and the Ukraine.

2. NORTH AMERICA: 30 day cruise travel from Italy around North America to

South America. Destinations include the Great Lakes, Canadian Islands, Bermuda, the West Indies, Cuba, Mexico, a barge trip through the Panama Canal to end destination, the port of Lima, Peru.

Substitutes: A. Railroad trip from New York to San Francisco with day stops in Chicago, New Orleans, Tucson, Albuquerque and San Francisco. B. Beach stays including Mexico, El Salvador, Bermuda, Jamaica and East Caribbean Islands. C. Dog sledding Nome, Alaska.

3. SOUTH AMERICA: 10 day hike the Inca Trail and visit The Lost City of The Incas, Machu Picchu, Peru. Sail to end destination Paradise Bay, Antarctica.

Substitutes: A. Tour National Parks in Brazil. B. Hike Torres del Paine Circuit, Patagonia Mountains, Chile. C. Amazon River Trip including Brazil, Colombia, Peru, Venezuela, Ecuador, Bolivia, Suriname.

4. ANTARCTICA 10 day seaplane tour to inhabited territories. Hike University Peak, Victoria Land, explore Alelie Land and meet the stars of the “March of the Penguins”. Air travel from Amundsen Scott Station to end destination Tasmania.

Substitute: A. Ice climbing in the Arctic Andes and bathing in the thermal lakes of Victoria Land.

5. OCEANIA: 10 days explore by land and sea Tasmania and Pacific Island beaches and volcanos including Solomon Islands, Marshall Islands, Somoa and Figi. First class air travel from Brisbane to end destination Tanzania.

Substitutes: A. Tour the capitals of Australia and New Zealand. B. Explore the Australian outback.

6. AFRICA: 10 day safari Serengeti National Park, Tanzania, Africa. First Class Air. Travel to end destination Badaling Area, Mainland China.

Substitutes: A. Explore the pyramids of Egypt. B. Gold mining in South Africa. C. Shop the open markets of Casablanca, Morocco.

7. ASIA: 10 days to explore the Great Wall of China, Badaling Area, Mainland China, and the China coast. First class air travel from Hong Kong to final end destination Rome, Italy.

Substitutes: A. The lightness of being, Bali, Indonesia. B. Visit the Taj Mahal and explore India. C. Explore the Middle East Gulf Coast including Iraq, Jordan, Bahrain, Algeria and Libya. D. Visit Yakutsk, Russia, the coldest place on the earth.

### Tours—World Library and Museum Tour

TOTAL COST: $5,000.00 (Deposit $1,250.)

START AND END DESTINATION: The Library of Congress, Washington, D.C., North America.

Itinerary:

1. NORTH AMERICA—10 days to explore the Library of Congress and the Smithsonian Mall Museums and Monuments, Washington, D.C., air travel to the Pollock Krasner House, East Hampton, N.Y. to end destination Rio de Janiero, Brazil.

Substitute: A. National Library of Mexico, Mexico City, Mexico.

2. SOUTH AMERICA—10 days National Library of Brazil, Rio de Janeiro and the Museum Imperial, Brazil to end destination The Hague, Amsterdam.

Substitute: A. National Library of Chile, Santiago, Chile. B. National Library of the Argentine Republic, Buenos Aires, Argentina.

3. EUROPE—20 days The Library of the Netherlands, The Hague, Amsterdam to the end destination The Catherine Palace, Summer Palace of the Czars, St Petersburg. Explore The European Library, an Internet service that allows access to the resources of 48 European national libraries).

Substitutes: A. Cyprus Library, Nicosia, Greece. B. National and University Library of Iceland, Reykjavik, Iceland. C. National Library of Greenland, Nuuk, Greenland.

4. ASIA—10 days The National Library of China, Beijing, China to end destination Democratic Republic of the Congo.

Substitutes: A. Hong Kong Central Library, Hong Kong, SAR, Republic of China. B. National Library of Korea, Seoul, South Korea. C. National Library of Cambodia, Phnom Penh, Cambodia. E. United Arab Emirates Cultural Foundation National Library, Abu Dhabi, UAE.

5. AFRICA—10 days National Library of the Democratic Republic of Congo, Kinshasa, to end destination Canberra, Australia.

Substitutes: A. Library of Ethiopia, Addis Ababa, Ethiopia. B. National Library of Uganda, Kampala, Uganda, Africa.

6. OCEANIA—10 days The National Library of Australia, Canberra to Victoria Land, Antarctica.

7. ANTARCTICA—10 days Buckminster Fuller Library, University of Antarctica, Victoria. Land to start destination The Library of Congress, Washington, D.C.

Tours—Hike and Bike Camping Tour

TOTAL COST: $2,500.00 (Deposit $625.)

START AND END DESTINATION: West Coast Trail, British Columbia, Canada, North America.

Itinerary:

1. NORTH AMERICA—20 days bike the West Coast Trail, British Columbia, Canada and hike the end destination Half Dome Hike, Yosemite National Park, Calif., United States airfare to Patagonia, Chile.

2. SOUTH AMERICA—10 day bike the Torres del Paine Circuit, Patagonia Mountains, Chile and hike the Inca Trail, Peruvian Mountains, Peru air travel to the Alps, France.

3. EUROPE—10 days bike the Tour de Mont Blanc, French Alps, France and hike the Tatra Mountains of Slovakia air travel to Nepal, India.

4. ASIA—10 days hike around the Annapurna Circuit, Nepal, India and Tiger Leaping Gorge, Yangtzee River, China air travel to Tanzania, Africa.

5. AFRICA—10 days hike the base of Mount Kilimanjaro, Tanzania, Africa and Mount Kenya, Kenya travel to Hawaii.

6. OCEANIA—10 days hike Kalalau Trail, Kauai, Hawaii and the Tongariro Northern Circuit, North Island, New Zealand air travel to Antartica.

7. ANTARCTICA—10 days hike the Artic Andes and air travel back to British Columbia, Canada.

Overnight Interest Rates and Currency Spot Rates Tour Destination, USD, EUR

1. AFRICA—CURRENCY AFRO AFR

CENTRAL BANK OF AFRICA OVERNIGHT INTEREST RATE 5% AFRO

CURRENCY $0.10=1 AFR10 AFR=1 USD

| | | |
|---|---|---|
| Tanzania 12% | South Africa 15% | Egypt 12% |
| $.000625 = 1 TZS | $.1514 = 1 ZAR | $.20 = 1 EGP |
| TZS185 = 1 AFR | ZAR8 = | EGP.625 = 1 |
| Ethiopia 7% | Uganda 20%* | Democratic Rep. |
| $.05 = 1 ETB | $.0004 = 1 UGX B | of the Congo 50%* |
| ETB2.5 = 1 AFR | UGX 300 = 1 AFR | $.001 = 1 CDF |
| | | CDF110 = 1 AFR |
| Kenya $.01 = 1 KES | Morocco $.01 = 1 | |
| 13% | MAD 4% | |
| KES10 = 1 AFR | MAD10 = 1 AFR | |

2. ANTARCTICA—CURRENCY ANTARCTICAN DOLLAR ARC

Central Bank of Antarctica Overnight Interest Rate NA SPOT RATE ARC $0.625=1 ARC 1.6 ARC=1 USD

| | | |
|---|---|---|
| Australia 5% | New Zealand 9% | Argentina 15% |
| $1.10 = 1 AUD | $.80 = 1 NZD | $.25 = 1 ARS |
| .625 AUD = 1 ARC | .625 NZD = 1 ARC | 2.5 ARS = 1 ARC |
| Chile 13% | Europe 4% | Germany 5% |
| $.002 = 1 CLP | $1.60 = 1 EUR | $1.40 = 1 DEM |
| 320 CLP = 1 ARC | .50 EUR 1 ARC | .625 DEM = 1 ARC |
| Norway 7% | Russia 12% | United States 1.5% |
| $.20 = 1 NOK | $.04 = 1 RUB | $.625 = 1 ARC |
| 4 NOK = 1 ARC | 20 RUB = 1 ARC | 1.6 ARC = 1 USD |

*Borrowing Rate Only

3. ASIA—CURRENCY ASIAN RUBLE ARB

CENTRAL BANK OF ASIA OVERNIGHT INTEREST RATE 7% SPOT RATE $0.08=1 ARB 12.5 ARB=1 USD

| | | |
|---|---|---|
| India 12% | China 7% | Hong Kong 7% |
| $.0125 = 1 INR | $.1625 = 1 CNY | $.125 = HKD |
| 15 INR = 1 ARB | .625 CNY = 1 ARB | .8 HKD = 1 ARB |
| Russian Federation 15% | South Korea 5% | Cambodia NA |
| $.06 = 1 RUB | $.001 = KRW | $.0002 = 1 KHR |
| 2.5 RUB = 1 ARB | 120 KRW = ARB | 525 KHR = 1 ARB |
| Indonesia 15% | United Arab | |
| $.0001 = 1 IDR | Emirates 0% | |
| 550 IDR = 1 ARB | $.25 = 1 AED | |
| | .25 AED = 1 ARB | |

4. EUROPE—CURRENCY EURO EUR

EUROPEAN BANK OVERNIGHT INTEREST RATE 3% SPOT RATE $0.80/EUR

EUR1.20/USD

| | | |
|---|---|---|
| Spain 3% | Portugal 3% | Italy 3% |
| $.00625 = 1 ESP | $.005 = 1 PTE | $.000625 = 1 ITL |
| 165 ESP = 1 EUR | 200 PTE = 1 EUR | 1900 ITL = 1 EUR |
| Greece 3% | Cyprus NA | France 3% |
| $.0038 = 1 GRD | $2.00 = 1 CYP | $.20 = 1 FRF |
| 340 GRD = 1 EUR | .6 CYP = 1 EUR | 6.25 FRF = 1 EUR |
| Amsterdam 4.5% | Belarus 8% | Estonia 8% |
| $.50 = 1 NLG | $.001 = 1 BYR | $.08 = 1 EEK |
| 2.25 NLG = 1 EUR | 1,000 BYR = 1 EUR | 12.5 EEK = 1 EUR |
| Ukraine 20% | | |
| $.12 = 1 UAH | | |
| 9 UAH = 1 EUR | | |

5. NORTH AMERICA—CURRENCY NORTH AMERICAN DOLLAR NAD CENTRAL BANK OF NORTH AMERICAN OVERNIGHT RATE '1.5% SPOT RATE NAD $0.625=NAD 1.6 NAD=USD

| | | |
|---|---|---|
| United States of | Canada 2.5% | Bermuda NA |
| America 1.5% | $1.10 = 1 CAD | $1.00 = 1 BMD |
| $1.00 = 1 USD | .8 CAD = 1 NAD | .625 BMD = 1 NAD |
| .625 USD = 1 NAD | | |
| Trinidad and Tobago 10% | Bahama Islands NA | Cuba NA |
| $.125 = 1 TND | $1.00 = 1 BSD | $.04 = 1 CUP |
| 8 TND = 1 NAD | .625 BSD = 1 NAD | 20 CUP = 1 NAD |
| Mexico 7% | Panama 8% | |
| $.08 = 1 MXN | $.80 = 1 PAB | |
| 10 MXN = 1 NAD | 1.25 PAB = 1 NAD | |

6. OCEANIA—CURRENCY OCEANIA DOLLAR OCD

NATIONAL BANK OF OCEANIA OVERNIGHT INTEREST RATE 12.5% SPOT RATE OCD $0.625=1 OCD 1.6 OCD=1 USD

| | | |
|---|---|---|
| Australia 7% | New Zealand 9% | Papua New Guinea 10% |
| $1.10 = 1 AUD | $.80 = 1 NZD | $.40 = 1 PGK |
| 1.25 AUD = 1 OCD | 1.25 NZD = 1 OCD | 2 PGK = 1 OCD |
| Figi 9% | Solomon Islands 15% | Tasmania NA |
| $.50 = 1 FJD | $.1514 = 1 SBD | $.80 = 1 TSD |
| 2.5 FJD = 1 OCD | 6.625 SBD = 1 OCD | 1.25 TSD = 1 OCD |
| Somoa 12% | Tonga 12% | |
| $.625 = 1 SMD | $.625 = 1 TOP | |
| 1.6 SMD = 1 OCD | 1.6 SMD = 1 OCD | |

7. SOUTH AMERICA—CURRENCY SOUTH AMERICAN PESO SAP CENTRAL BANK OF SOUTH AMERICAN OVERNIGHT INTEREST RATE8% SPOT RATE SAP $0.20=1 SAP 5 SAP=1 USD

| | | |
|---|---|---|
| Chile 13% | Brazil 10% | Columbia NA |
| $.002 = 1 CLP | $.625 - 1 BRL | $.000625 = 1 COP |
| 250 CLP = 1 SAP | 1.2 BRL = 1 SAP | 1,000 COP = 1 SAP |
| Peru 25%* | Venezuela 20%* | Ecuador 10% |
| $.40 = 1 PEN | $.25 = 1 VEF | $.00004 = 1 ECS |
| 2 PEN = 1 SAP | 2 VEF = 1 SAP | 10,000 ECS = 1 SAP |
| Bolivia 12% | Surinname NA | |
| $.125 = 1 BOB | $.0003 = 1 SRG | |
| 6 BOB = 1 SAP | 1,500 SRG = 1 SAP | |

### Exhibit C—Travel Log

PLAYER:
START AND END DESTINATION:
TRAVEL EXPENSE RATE:
GAME STARTING DATE/TIME:
END DATE/TIME:

| ROUND | | | | |
|---|---|---|---|---|
| (5 Dys-1 Wk) | TRANSACTION | EXPENSE | | SCORE |
| Destination | (Buy, Sell, Borrow, | (travel and | | (US and foreign |
| Travel Miles | Lend) | transaction) | EARNINGS | currency in hand) |
| ONE | | | | $10,000 |
| TWO | | | | |
| THREE | | | | |
| FOUR | | | | |
| FIVE | | | | |
| SIX | | | | |
| SEVEN | | | | |
| EIGHT | | | | |
| NINE | | | | |
| TEN | | | | |
| ELEVEN | | | | |
| TWELVE | | | | |
| THIRTEEN | | | | |
| FOURTEEN | | | | |
| FIFTEEN | | | | |
| SIXTEEN | | | | |
| SEVENTEEN | | | | |
| EIGHTEEN | | | | |

1-18. (canceled)

19. A board-type game comprising:
a playing field surface comprising a plurality of demarcated regions;
a measuring device comprising:
a base portion comprising a first plurality of indices, the first plurality of indices corresponding to distances between the plurality of demarcated regions in accordance with a first distance scale;
a first diagonal portion disposed at an angle from the base portion and comprising a second plurality of indices, the second plurality of indices corresponding to the distances between the plurality of demarcated regions in accordance with a second distance scale, the second distance scale being different than the first distance scale; and
a second diagonal portion disposed at an angle from the base portion and comprising a third plurality of indices, the third plurality of indices corresponding to the distances between the plurality of demarcated regions in accordance with the second distance scale;
a plurality of playing pieces, each of the plurality of playing pieces being characterized by a different color and configured to mark the playing field surface with the respective color;
an eraser element configured to erase markings from the plurality of playing pieces on the playing field surface;
a first plurality of playing cards characterized by a first type;
a second plurality of playing cards characterized by a second type different than the first type;
a third plurality of playing cards characterized by a third type different than both the first type and the second type;
a ledger; and
a portable storage container comprising a handle and a closure element, the portable storage container being configured to enclose the playing field surface, the measuring device, the plurality of playing pieces, the plurality of playing cards, and the ledger.

20. The board-type game of claim 19, wherein the playing field surface is comprised of a flexible material.

21. The board-type game of claim 19, wherein the measuring device is comprised of a flexible material and configured to adhere to the playing field surface.

22. The board-type game of claim 19, wherein the playing field surface includes an image of a world map.

23. The board-type game of claim 22, wherein the plurality of demarcated regions include a plurality of countries.

24. The board-type game of claim 19, wherein the first type of the first plurality of playing cards is a destination type, and wherein each of the first plurality of playing cards of the destination type identify one or more of the plurality of demarcated regions of the playing field surface.

25. The board-type game of claim 19, wherein the second type of the second plurality of playing cards is a currency type, and wherein each of the second plurality of playing cards of the currency type identify a currency that corresponds to one or more of the plurality of demarcated regions of the playing field surface.

26. The board-type game of claim 19, wherein the third type of the third plurality of playing cards is an interest type, and wherein each of the third plurality of playing cards of the interest type identify one or more interest rate percentages.

27. The board-type game of claim 19, wherein the portable storage container comprises a plurality of separately sealable compartments.

28. The board-type game of claim 27, wherein the plurality of separately sealable compartments comprises a first compartment dimensioned to store the plurality of playing pieces and the eraser element, a second compartment dimensioned to store the playing field surface and the measuring device, and a third compartment dimensioned to store the first, second and third plurality of playing cards.

29. The board-type game of claim 19, wherein the portable storage container is characterized by a cylindrical geometry.

30. A method of playing the board-type game of claim 19, the method comprising:
recording in the ledger:
a travel expense rate;
a start destination corresponding to a first of the plurality of demarcated regions of the playing field surface;
an end destination corresponding to a second of the plurality of demarcated regions of the playing field surface; and
an initial currency value;
selecting:
a playing card from the first plurality of playing cards identifying an initial destination corresponding to a third of the plurality of demarcated regions of the playing field surface;
two playing cards from the second plurality of playing cards identifying one or more currency exchange rates; and
two playing cards from the third plurality of playing cards identifying one or more interest rates;
measuring, using the measuring device, a distance between the first of the plurality of demarcated regions and the third of the plurality of demarcated regions on the playing field surface;
calculating a travel expense value based on the measured distance and the travel expense rate recorded in the ledger;
calculating an earnings value based on the one or more currency exchanges rates and the one or more interest rates;
recording, in the ledger, the travel expense value, the earnings value, and a new currency value.

31. The method of claim 30, wherein the playing field surface includes an image of a world map.

32. The method of claim 31, wherein the plurality of demarcated regions include a plurality of countries.

33. The method of claim 32, wherein the plurality of countries are organized in a plurality of continents.

34. The method of claim 33, wherein the method is repeated until:
the start destination, the initial destination, the end destination, and one or more intervening destinations correspond to at least one demarcated region in each of the plurality of continents; and
the new currency value is greater than or equal to the initial currency value.

35. The method of claim 30, wherein the method comprises a round of game play, and wherein the method is repeated until a predetermined number of rounds of game play are reached.

36. The method of claim 30, wherein measuring the distance between the first of the plurality of demarcated regions and the third of the plurality of demarcated regions includes marking, using one of the plurality of playing pieces and the measuring device, a path between the first of the plurality of demarcated regions and the third of the plurality of demarcated regions on the playing field surface.
